(19) United States
(12) Patent Application Publication
(10) Pub. No.: US 2023/0148590 A1
(43) Pub. Date: May 18, 2023

(54) Aqueous Formulations of Dicamba

(71) Applicant: BASF CORPORATION, Florham Park, NJ (US)

(72) Inventors: Claude Taranta, Limbergerhof (DE); Steven Joseph Bowe, Research Triangle Park, NC (US); Ronald Repage, Research Triangle Park, NC (US); Stephan Koehler, Ludwigshafen (DE); Katja Marxer, Limbergerhof (DE); Thomas Bork, Limbergerhof (DE); Wolfgang Meier, Limbergerhof (DE); Marc Nolte, Limbergerhof (DE); Frank Dinies, Limbergerhof (DE); Michael Krapp, Limbergerhof (DE); Klaus Kolb, Schifferstadt (DE)

(21) Appl. No.: 17/915,587

(22) PCT Filed: Apr. 1, 2021
(86) PCT No.: PCT/EP2021/058689

§ 371 Date: Sep. 29, 2022

Related U.S. Application Data
(60) Provisional application No. 63/164,066, filed on Mar. 22, 2021.

(30) Foreign Application Priority Data
Apr. 2, 2020 (AR) P20200100930
Apr. 6, 2020 (US) PCT/US2020/026900

(51) Int. Cl. A01N 25/02; A01N 37/40; A01N 25/22

(52) U.S. Cl. CPC A01N 25/02; A01N 37/40; A01N 25/22

(57) ABSTRACT

The invention relates to an agrochemical composition comprising a salt of dicamba and an N—C₂-C₁₅-alkyl pyrrolidone. It also relates to a method of controlling undesired vegetation, and/or for regulating the growth of plants, wherein the agrochemical composition is allowed to act on the respective pests, their environment, or the crop plants to be protected from the respective pest, on the soil and/or on the crop plants and/or on their environment; to a method for producing the agrochemical composition; to an adjuvant composition for increasing the solubility of the salt of dicamba in an aqueous composition comprising an N—C₂-C₁₅-alkyl pyrrolidone.

This invention relates to an aqueous formulation, in particular aqueous SL formulations, containing a salt of dicamba, hereinafter referred to as dicamba-salt, in particular a dicamba-salt of dicamba and a water miscible organic amine, hereinafter referred to as dicamba-N, or the potassium salt of dicamba, hereinafter referred to as dicamba-K, and water.

Dicamba is the pesticide common name of 3,6-dichloro2-methoxybenzoic acid. Dicamba is a well-known herbicide compound of the group of synthetic auxins and suitable for controlling undesired vegetation, in particular for dicotyledons. Dicamba-salts are advantageous forms of dicamba, as they can be formulated in various agrochemical formulations, which can be handled easily and safely by the applicant. A particular group of dicamba formulations are aqueous formulations, in particular aqueous SL formulations of dicamba-salts.

Aqueous SL formulations, also referred to as “soluble liquids” or “soluble (liquid) concentrates”, are homogeneous solutions of the respective pesticide in an aqueous solvent which, beside water, may contain a water-miscible solvent. Usually, aqueous SL formulations can be easily diluted with water to the desired application concentration of the respective pesticide, and they are particularly suitable for tank mix with other pesticides.

Aqueous SL formulations of dicamba-salts are advantageous because dicamba can be formulated in high concentrations of typically at least 300 g/L and because they contain only minor amounts of organic solvents with respect to the dicamba. The total amount of formulation can be minimized, making it particularly beneficial for treatment of large acreages.

Unfortunately, aqueous SL-formulations of Dicamba may not be entirely stable against formation of insoluble precipitates, in particular if the SL-formulations are stored at cold temperatures. Without being bound by theory, it is believed that the formation of precipitates may be caused by some by-products formed in the production process of the dicamba herbicides.

Unfortunately, these precipitates cannot be readily re-dissolved by warming the formulation, and they may cause clogging of the spray nozzle equipment which makes dosing of dicamba more difficult.

Mitigation of off-target movement of pesticides from the treated area minimizes potential negative environmental impacts and maximizes the efficacy of pesticide where it is most needed. By their nature, herbicides affect sensitive plants and mitigating their off-target movement reduces their effect on neighboring crops and other vegetation, while maximizing weed control in the treated field. Off-target movement can occur through a variety of mechanisms generally divided into primary loss (direct loss from the application equipment before reaching the intended target) and secondary loss (indirect loss from the treated plants and/or soil) categories. Primary loss from spray equipment typically occurs as fine dust or spray droplets take longer to settle and can be more easily blown off-target by wind. Off-target movement of spray particles or droplets is typically referred to as ‘spray drift’. Primary loss can also include when contaminated equipment is used to make an inadvertent application to a sensitive crop. Contamination may occur when one product (i.e. pesticide) is not adequately cleaned from spray equipment and the contaminated equipment is later used to apply a different product to a sensitive crop resulting in crop injury. Secondary loss describes off-target movement of a pesticide after it contacts the target soil and/or foliage and moves from the treated surface by means including airborne dust (e.g. crystalline pesticide particles or pesticide bound to soil or plant particles), volatility, i.e. a change of state from the applied solid or liquid form to a gas, or run-off in rain or irrigation water. Off-target movement is typically mitigated by proper application technique, e.g. spray nozzle selection, nozzle height and wind limitations, and improved pesticide formulation. This is also the case for dicamba where the proper application technique mitigates potential primary loss and equipment contamination. Secondary loss for dicamba has been further reduced through the development of formulations using improved dicamba salts such as BAPMA dicamba.

WO 2011/019652 describes aqueous formulations of dicamba-salts which contain a polymeric amine to reduce off-target movement and volatility of the formulation. The formulations may suffer from cold-storage stability.

It is therefore desirable to provide aqueous formulations of dicamba-salts which mitigate at least some of the aforementioned problems. In particular, the aqueous formulations should be less sensitive to the formation of precipitates during cold storage. The formulations should have good biological activity, display favorable spraying properties and are safe to handle during application. It is furthermore desirable to provide aqueous formulations, in particular SL formulations, of dicamba-salts that have a high load of dicamba and that do not have the aforementioned stability problems.

It is also desirable to provide formulations that can be admixed to formulations of glyphosate and/or glufosinate and/or their salts—particularly the ammonium, diammonium, isopropylammonium and potassium salt of glyphosate and/or glufosinate—or which can be tank-mixed with, and the formulations of glyphosate and/or glufosinate and/or their salts. Such pesticidal coformulations comprising dicamba and glyphosate and/or glufosinate should be less sensitive to formation of precipitates, display favorable spraying properties, have a good biological activity, and are safe to handle during application.

It was surprisingly found that these and further objectives are solved by the aqueous formulations of dicamba-salts, which contain at least one organic solvent selected from N—C₂-C₁₅-alkyl pyrrolidones, wherein the alkyl radical may carry a hydroxyl group, in particular from N—C₃-C₁₂-alkyl pyrrolidones, more particularly from N—C₃-C₆-alkyl pyrrolidones.

Therefore, a first aspect of the invention relates to aqueous formulations of dicamba, in particular aqueous SL-formulations, which contain
a) dicamba in the form of a dicamba salt, and
b) at least one organic solvent, which is selected from N—C₂-C₁₅-alkyl pyrrolidones, wherein the alkyl radical may carry a hydroxyl group, which is herein referred to as solvent b).

A further (second) aspect of the invention also relates to a method for producing the aqueous formulation of a dicamba-salt as defined herein which comprises the step of mixing the dicamba salt with water and at least one solvent b) and optionally further ingredients of the formulation.

Yet another (third) aspect of this invention also relates to a method for controlling undesired vegetation and/or for regulating the growth of plants, wherein an aqueous formulation of a dicamba-salt as defined herein is allowed to act on the respective pests, their environment, or the crop plants to be protected from the respective pest, on the soil and/or on the crop plants and/or on their environment.

A further (fourth) aspect of the invention relates to the use of a solvent b) as defined herein for reducing the formation of precipitates in aqueous formulations, in particular in aqueous SL formulations, containing a salt of dicamba.

It was also found that combinations of the solvent b) as defined herein with at least one additive d) imparts stability to aqueous formulations of dicamba salts and in particular of dicamba-K. Said additive d) is selected from the group consisting of
d1) polyalkylene oxide block-copolymers of formula (I)

R¹O(EO)ₙ(PO)ₘ(EO)ₚR² (I),
wherein
EO is CH₂CH₂O;
PO is CH₂CH(CH₃)O;
R¹, R² are H, or C₁-C₃-alkyl;
n, p are independently a natural number from 10 to 250; and
m is a natural number from 10 to 100; and
d2) hyperbranched polycarbonates which are connected to a linear polymer comprising polyethylene oxide.

The additive d) may be combined with one or more solvents e) which are selected from the group consisting of C₁-C₅-alkyl lactates, C₃-C₅-lactones and mixtures thereof.

Therefore, a further (fifth) aspect of the invention relates to an adjuvant composition comprising a mixture of the solvent b) as defined herein and at least one of additive d) selected from d1) the polyalkylene oxide block-copolymers of formula (I) and d2) the hyperbranched polycarbonates and combinations of d1) and d2) and optionally one or more solvents e). A sixth aspect of the invention relates to the use of these adjuvant compositions for increasing the stability of an aqueous formulation of a dicamba salt against formation of precipitates.

The solvent b) as defined herein and the combinations of solvent b) with one or both of additives d1) and/or d2) and/or with solvent e) are capable of reducing the formation of fine droplets, when spraying an aqueous dilution of a formulation of a salt of dicamba, i.e. of an aqueous spray liquor obtained by diluting a formulation of a salt of dicamba with water. Therefore, a further (seventh) aspect of the invention relates to the use of a solvent b) as defined herein or a combination of the solvent b) and at least one further component selected from the group consisting of additives d1) and d2) and solvent e) as defined herein for reducing the formation of fine droplets when spraying an aqueous dilution of a formulation of a salt of dicamba, in particular an aqueous SL formulation of a salt of dicamba. A further (eighth) aspect of the present invention relates to a method for reducing the formation of fine droplets when applying an aqueous spray liquor obtained by diluting a formulation of a salt of dicamba, in particular an aqueous SL formulation of a salt of dicamba. This method comprises the step of including a solvent b) as defined herein or a combination of solvent b) and at least one component selected from the group consisting of additives d1) and d2) and solvent e) as defined herein into the spray liquor or into the formulation of the salt of dicamba.

The following remarks apply to each of the aspects of the invention. Combinations of embodiments with other embodiments, irrespective of their individual level of preference, are within the scope of the invention.

The prefix Cₙ-Cₘ refers to the number of carbon atoms a molecule or radical may have. For example, Cₙ-Cₘ-alkyl refers to the group of linear or branched alkyl radicals having from n to m carbon atoms. In particular, C₁-C₃-alkyl refers to the group of alkyl radicals having 1 to 3 carbon atoms, while C₂-C₁₅-alkyl refers to the group of alkyl radicals having 2 to 15 carbon atoms, and so on.

In the context of the present invention aqueous SL formulations, also referred to as “soluble liquids” or “soluble (liquid) concentrates”, are virtually homogeneous solutions of the ingredients in an aqueous solvent which, beside water contains at least one solvent b). Virtually homogeneous means that the formulations are optically clear, i.e. they are not turbid or contain solids.

The aqueous formulation contains at least one organic solvent b) selected from the group consisting of N—C₂-C₁₅-alkyl pyrrolidones, in particular from the group consisting of N—C₃-C₁₂-alkyl pyrrolidones and more particularly from the group of N—C₃-C₈-alkyl pyrrolidones. The alkyl radical may be unsubstituted or may carry a hydroxyl group. In particular, the alkyl radical is unsubstituted. The alkyl radical may be branched or linear. In particular, the alkyl radical is linear. Examples of solvents b) include, but are not limited to N-ethyl pyrrolidone, N-(2-hydroxyethyl) pyrrolidone, N-(n-propyl) pyrrolidone, N-(2-propyl) pyrrolidone, N-(n-butyl) pyrrolidone, N-(2-butyl) pyrrolidone, N-(isobutyl) pyrrolidone, N-(tert.-butyl) pyrrolidone, N-(n-pentyl) pyrrolidone, N-(n-hexyl) pyrrolidone, N-(2-hexyl) pyrrolidone, N-(n-heptyl) pyrrolidone, N-(2-heptyl) pyrrolidone, N-(n-octyl) pyrrolidone, N-(2-octyl) pyrrolidone, N-(2-ethyl-1-hexyl) pyrrolidone, N-(n-nonyl) pyrrolidone, N-(n-decyl) pyrrolidone, N-(n-undecyl) pyrrolidone, N-(n-dodecyl) pyrrolidone, N-(n-tridecyl) pyrrolidone, N-(n-tetradecyl) pyrrolidone, or N-(n-pentadecyl) pyrrolidone. Preference is given to N—C₃-C₁₂-alkyl pyrrolidones and more particularly to the group of N—C₃-C₈-alkyl pyrrolidones.

In particular, solvent b) comprises at least one N—C₃-C₆-alkyl pyrrolidone, where the alkyl radical is linear, more particularly at least one N—C₃-C₆-alkyl pyrrolidone, where the alkyl radical is linear and especially N-(n-butyl) pyrrolidone. In a particular group (1) of embodiments solvent b) is selected from N—C₃-C₆-alkyl pyrrolidones, where the alkyl radical is linear, more particularly from N—C₄-C₅-alkyl pyrrolidones, where the alkyl radical is linear, and especially the solvent b) is N-(n-butyl) pyrrolidone. In a second group (2) of embodiments, solvent b) is a combination of at least one N—C₃-C₆-alkyl pyrrolidone, where the alkyl radical is linear, more particularly at least one N—C₃-C₆-alkyl pyrrolidone, where the alkyl radical is linear and especially N-(n-butyl) pyrrolidone, with at least one further N—C₂-C₁₅-alkyl pyrrolidone different therefrom, in particular with at least one N—C₇-C₁₅-alkyl pyrrolidone. Examples of such combinations are the combination of N-(n-butyl) pyrrolidone with N-(n-octyl) pyrrolidone and/or N-(n-dodecyl) pyrrolidone.

In the aqueous formulation of the present invention, the amount of N—C₂-C₁₅-alkyl pyrrolidone is usually in the range of 10 to 200 g/l, in particular in the range of 15 to 100 g/l, preferably in the range of 20 to 80 g/l, and especially in the range of 25 to 60 g/l. These amounts usually correspond to concentrations of N—C₂-C₁₅-alkyl pyrrolidone in the range of 0.8 to 16 wt %, in particular in the range of 1.2 to 8.0 wt %, preferably in the range of 1.5 to 6.5 wt % and especially in the range of 2.0 to 5.0 wt %, based on the total weight of the formulation.

The aqueous formulation of the present invention generally contains the dicamba-salt in an amount such that the concentration of dicamba, calculated as the free acid, is at least 350 g/I, in particular at least 380 g/l, especially at least 400 g/l, based on the total volume of the formulation. Usually, the concentration of the salt will not be higher than 850 g/l, in particular not higher than 830 g/l or 810 g/l and is generally in the range of 350 to 850 g/l, in particular in the range of 380 to 830 g/l and especially in the range of 400 to 810 g/l, based on the total volume of the formulation.

The aqueous formulation of the present invention generally contains the dicamba-salt in a concentration of at least 450 g/l, in particular at least 500 g/l, especially at least 520 g/l, based on the total volume of the formulation. Usually, the concentration of the salt will not be higher than 1000 g/l, in particular not higher than 975 g/l or 950 g/l and is generally in the range of 450 to 1000 g/l, in particular in the range of 500 to 975 g/l and especially in the range of 520 to 810 g/l, based on the total volume of the formulation.

The aqueous formulation of the present invention generally contains the dicamba-salt in a concentration of at least 30 wt %, in particular at least 35 wt %, preferably at least 40 wt %, especially at least 42 wt %, based on the total weigh of the aqueous formulation. The concentration of the dicamba salt will typically not exceed 80 wt %, in particular 75 wt %, based on the total weight of the aqueous formulation. In particular, the concentration of the dicamba-salt in the aqueous formulation is in the range of 35 to 80 wt %, preferably in the range of 40 to 75 wt %, especially in the range of 42 to 70 wt % based on the total weight of the agrochemical composition.

In the aqueous formulation of the present invention the dicamba-salt is typically completely dissolved at 20° C.

The agrochemical composition typically contains one or more secondary components, which are by-products of the dicamba manufacturing process. Such by-products include 3,5-dichloro-2-methoxybenzoic acid (CAS 22775-37-7), 3,6-dichloro-2-hydroxybenzoic acid (CAS 3401-80-7), 3,5-dichloro-2-hydroxybenzoic acid (CAS 320-72-9), 3-chloro-2,6-dimethoxybenzoic acid (CAS 36335-47-4), 3,4-dichloro-2-methoxybenzoic acid (CAS 155382-86-8), 3,4-dichloro-2-hydroxybenzoic acid (CAS 14010-45-8), and/or 3,5-dichloro-4-methoxybenzoic acid (CAS 37908-97-7), or their salts. At least some of these compounds are generally prone to form insoluble precipitates in common liquid aqueous formulations. These precipitates may form sediments over time or cause turbidity of the liquid aqueous formulation. In other words, at least some of the secondary components cause instability of aqueous formulations of dicamba-salts. In extreme cases, this instability may result in clogging the spray nozzle equipment and making dosing of the concentrated formulation of the dicamba salt more difficult. The inventive formulations of dicamba-salts mitigate the problems associated with these secondary components.

The relative amount of all secondary components with respect to the total mass of dicamba in the aqueous formulation, calculated as the free acid of dicamba and the free acid of the secondary components, is usually in the range of 1 wt % to 20 wt %. The relative amount may be at least 1.5 wt %, in particular at least 2 wt %, especially at least 5 wt %. The relative amount secondary component with respect to dicamba may be up to 18 wt %, in particular up to 15 wt %, especially up to 10 wt %. In particular, the relative amount of all secondary components with respect to the total mass of dicamba in the aqueous formulation, calculated as the free acid of dicamba and the free acid of the secondary components, is in the range of 1.5 wt % to 15 wt % and especially in the range of 2 wt % to 10 wt %.

Without being bound by theory, it is believed that this instability is in particular caused by at least one of the aforementioned dichloro-2-hydroxybenzoic acid compounds, i.e. by one of 3,6-dichloro-2-hydroxybenzoic acid, 3,5-dichloro-2-hydroxybenzoic acid and 3,4-dichloro-2-hydroxybenzoic acid and combinations thereof.

It was surprisingly found that these secondary components, which have a low water-solubility, are kept dissolved in the formulation of the present invention because of the presence of solvent b) or a combination thereof with at least one further component, selected from additive d1), additive d2) and solvent e). Therefore, the aqueous formulation of the dicamba-salt which contains at least one solvent b) or a combination thereof with at least one further component, selected from additive d1), additive d2) and solvent e), stays clear, homogeneous and transparent, even if stored at low temperatures of less than 10° C. and even less than 0° C.

In one embodiment, the formulation of the present invention contains 3,5-dichloro-2-methoxybenzoic acid as a secondary component. In another embodiment, the formulation of the present invention contains the side product 3,6-dichloro-2-hydroxybenzoic acid. In another embodiment, the formulation of the present invention contains the side product 3,6-dichloro-2-hydroxybenzoic acid. In another embodiment, the formulation of the present invention contains the side product 3,5-dichloro-2-hydroxybenzoic acid. In yet another embodiment, the formulation of the present invention contains the side product 3-chloro-2,6-dimethoxybenzoic acid. In yet another embodiment, the formulation of the present invention contains the side product 3,4-dichloro-2-methoxybenzoic acid. In yet another embodiment, the formulation of the present invention contains the side product 3,4-dichloro-2-hydroxybenzoic acid. In a further embodiment, the formulation of the present invention contains the side product 3,5-dichloro-4-methoxybenzoic acid. In particular, the formulation of the present invention contains 3,5-dichloro-2-methoxybenzoic acid, 3,6-dichloro-2-hydroxybenzoic acid and 3,5-dichloro-2-hydroxybenzoic acid as secondary components.

Usually, the relative amount of the 3,5-dichloro-2-methoxybenzoic acid relative to the total mass of dicamba in the formulation may be in the range of 0.5 wt % to 10 wt %, in particular in the range of 1 wt % to 8 wt %. The relative amount of the 3,6-dichloro-2-hydroxybenzoic acid relative to the total mass of dicamba in the formulation may be in the range of 0.1 wt % to 10 wt %, in particular in the range of 0.2 wt % to 5 wt % or in the range of 0.5 wt % to 5 wt %. The relative amount of the 3,5-dichloro-2-hydroxybenzoic acid relative to the total mass of dicamba in the formulation may be in the range of 0.1 wt % to 10 wt %, preferably in the range of 0.2 wt % to 5 wt %. In particular, the relative amount of the 3,5-dichloro-2-hydroxybenzoic acid relative to the total mass of dicamba in the formulation is in the range of 0.5 wt % to 5 wt %, in the range of 0.8 wt % to 3 wt %.

The total amount of the secondary components of the group of dichloro-2-hydroxybenzoic acids with respect to the total mass of dicamba in the aqueous formulation, calculated as the free acid of dicamba and the free acid of the dichloro-2-hydroxybenzoic acid compounds, is usually in the range of 0.5 wt % to 18 wt %, in particular in the range of 0.7 wt % to 15 wt % and especially in the range of 1.0 wt % to 10 wt %.The secondary component may be present as a free carboxylic acid, or in the form of a salt. Preferably it is present in the form of a salt, in particular a salt having the same counterion as the dicamba salt contained in the formulation.

The aqueous formulation of the invention typically has a pH in the range of pH 6.0 to pH 11.0, in particular in the range of pH 6.5 to pH 10.5, especially in the range of pH 7.0 to pH 10.2. The pH values of the aqueous formulations given here refer to the pH values determined at 22° C. and 1 bar in the undiluted aqueous formulation by means of a glass electrode.

The aqueous formulation of the invention may contain an inorganic buffer as a further component d). The type of buffer is preferably chosen to keep the pH of an aqueous dilution of the aqueous formulation in the range of pH 4.5 to pH 6.5 and in particular in the range of pH 5.0 to pH 6.0.

Preferably, the inorganic buffer is selected from the group of alkalimetal carbonates such as sodium carbonate and potassium carbonate. In particular, the buffer is potassium carbonate.

If present, the amount of the buffer is preferably in the range of 50 to 300 g/L, in particular in the range of 80 to 200 g/l, especially in the range of 110 or 180 g/l, based on the volume of the formulation, or in the range of 4 to 24 wt %, in particular in the range of 6.2 to 16 wt %, especially of 8.5 to 13.6 wt %, based on the total weight of the formulation.

If component a) is a salt of dicamba with an amine, the aqueous formulation preferably contains an inorganic buffer, in particular potassium carbonate.

In case of aqueous formulations containing an alkalimetal salt of dicamba as component a), such as dicamba-K or dicamba-Na, no buffer is required. Therefore, aqueous formulations containing an alkalimetal salt of dicamba as component a) usually do not contain an inorganic buffer.

The aqueous formulation of the present invention contains water. The amount of water is preferably chosen such that the components of the formulation form a virtually homogeneous solution. Such a formulation is also referred to as an aqueous SL formulation, or briefly as an aqueous SL (soluble liquid). The water-content is usually at least 10 wt %, in particular at least 15 wt %, preferably at least 20 wt %, especially preferably at least 22 wt %, such as at least 25 wt % based on the total weight of the aqueous formulation. The water content will usually not exceed 60 wt % and is in particular up to 50 wt % and especially up to 45 wt %, based on the total weight of the agrochemical composition. The water content is usually in the range of 10 to 60 wt %, in particular in the range of 15 to 50 wt % and especially in the range of 20 to 45 wt % based on the total weight of the agrochemical composition.

A group (3) of embodiments relates to aqueous formulations, where the dicamba-salt is a salt of dicamba with a water-miscible amine. These salts are hereinafter abbreviated as dicamba-N.

In this context, the term “water miscible” refers to amines that are completely miscible with deionized water a temperature of 298 K and 1 bar or which are soluble in water at a temperature of 298 K and 1 bar in an amount of at least 100 g/L.

Suitable organic amines miscible with water are those which have at least one amino group, wherein 1, 2 or 3 of the amino hydrogen atoms are replaced by an alkyl group, a hydroxyalkyl group, an alkoxyalkyl group, a hydroxyalkyloxyalkyl group, an aminoalkyl group, an alkylaminoalkyl group, a dialkylaminoalkyl group, a N-(aminoalkyl)aminoalkyl, a N—(N′,N′-dialkylaminoalkyl)aminoalkyl group etc. In this context alkyl and alkoxy have preferably 1 to 4 carbon atoms, in particular 1 or 2 carbon atoms, while the substituted alkyl moieties of alkoxyalkyl, hydroxyalkyloxyalkyl, aminoalkyl group, alkylaminoalkyl, dialkylaminoalkyl, N-(aminoalkyl)aminoalkyl and N—(N′,N′-dialkylaminoalkyl)aminoalkyl preferably have 2 to 4 carbon atoms.

Preference is given to amines that have a primary or secondary amino group and at least one further functional group which is selected from a primary amino group, a secondary amino group, a tertiary amino group, a hydroxyl group, and an ether group.

Examples of suitable amines which are miscible with water include but are not limited to dimethylamine, diethylamine, n-propylamine, isopropylamine, 2-hydroxyethylamine (olamine or MEA), 2-(2-hydroxyethoxy)eth-1-ylamine (diglycolamine or DGA), di(2-hydroxyeth-1-yl)amine (diolamine), tri(2-hydroxyethyl)amine (trolamine), tris(3-propanol)amine, tris-(hydroxypropyl)-amine (tripromine), N-(3-aminopropyl)-N-methylamine, N,N-bis-(3-aminopropyll)-N-methylamine (biproamine, BAPMA), N,N-dimethyldipropylenetriamine (DMAPAPA). Further examples are oligomeric amines having a number average molecular weight in the range of 200 to 500 g/mol, such as polyetheramines, like Jeffamine types having a number average molecular weight in the range of 200 to 500 g/mol and oligomeric polyamines such as polyalkylene imines and N-substituted polyalkyleneimines, such as poly-N,N-bis-(3-aminopropyl)methylamine (MPPI).

Amongst the formulations of group (1) of embodiments, preference is given to formulations where component a) is a salt of dicamba with an amine selected from the group consisting of monoalkanolamines, N,N-dialkanolamines, N-(dialkyleneglycol)amines and N-(aminoalkyl)alkylamines, N,N-bis(aminoalkyl)alkylamines and N—(N,N-dialkylaminoalkylamino)alkylamine, in particular from the group consisting of mono-C₂-C₄-alkanolamines, N,N-bis(C₂-C₄-alkanol)amines, N-(di-C₂-C₄-alkyleneglycol)amines and N-(amino-C₂-C₄-alkyl)-C₁-C₂-alkylamines, N,N-bis(amino-C₂-C₄-alkyl)-C₁-C₂-alkylamines, N—(N′,N′-di-C₁-C₂-alkylamino-C₂-C₄-alkyl)-C₁-C₂-alkylamines and especially from the group consisting of N-(di-C₂-C₄-alkyleneglycol)amines and N,N-bis(amino-C₂-C₄-alkyl)-C₁-C₂-alkylamines.

Amongst the formulations of group (1) of embodiments, particular preference is given to formulations, where component a) is a salt of dicamba with an amine which is selected from the group consisting of 2-hydroxyethylamine (olamine or MEA), 2-(2-hydroxyethoxy)eth-1-ylamine (diglycolamine or DGA), di(2-hydroxyeth-1-yl)amine (diolamine), tri(2-hydroxyethyl)amine (trolamine), N-(3-aminopropyl)-N-methylamine, N,N-bis-(3-aminopropyl)-N-methylamine (BAPMA) and N,N-dimethyldipropylenetriamine (DMAPAPA), and where the amine is especially DGA or BAPMA.

A special group (3a) of embodiments relates to formulations where component a) is a salt of dicamba with DGA.

A special group (3b) of embodiments relates to formulations where component a) is a salt of dicamba with BAPMA.

The salts of dicamba with an amine (Dicamba-N) are known, and most of them are commercially available. Dicamba N can be prepared by reaction of the free acid form of dicamba with one of the aforementioned amines. Dicamba-N may refer to a 1:1 salt of dicamba with the amine but may also refer to molar ratios other than 1:1, as long as the molar amount of amine is sufficient to neutralize. If the amine bears more than 1 amino group, the molar ratio of amine to dicamba is typically at least (1/n):1, in particular in the range of (1/n) 1 to (1.5/n):1, especially in the range of (1/n):1 to (1.3/n):1, where n is the number of amino groups in the amine. For example in case of DGA, the molar ratio of dicamba to DGA is in the range of 1:1 to 1.5:1, in particular in the range of 1:1 to 1.3:1. In case of BAPMA, the ratio is typically at least 0.34:1 and in particular in the range of 0.34:1 to 0.5:1, especially in the range of 0.35:1 to 0.43:1.

The above disclosure with regard to the type of component b), its amounts, the concentrations of dicamba salt, the type and amount of secondary components, the presence and amount of buffer, pH and the amount of water apply to the groups (3), (3a) and (3b) of embodiments.

In particular, the groups (3), (3a) and (3b) of embodiments relate to aqueous formulations, of dicamba, in particular aqueous SL-formulations which contain
a) 450 to 1000 g/l, in particular in the range of 500 to 975 g/l and especially in the range of 520 to 810 g/l, based on the total volume of the formulation, of a dicamba salt with a water-miscible amine;
b) 10 to 200 g/l, in particular 15 to 100 g/l, preferably in the range of 20 to 80 g/l and especially 25 to 60 g/l of at least one organic solvent b), which is selected from N—C₂-C₁₅-alkyl pyrrolidones, wherein the alkyl radical may carry a hydroxyl group, where the solvent b) is preferably selected from the group consisting of N—C₃-C₁₂-alkyl pyrrolidones and more particularly from the group of N—C₃-C₈-alkyl pyrrolidones and where especially the solvent b) comprises or is N-(n-butyl) pyrrolidone;
c) optionally 50 to 300 g/l, in particular 80 to 200 g/l, especially 110 to 170 g/l of an inorganic buffer, which is preferably selected from alkalimetal carbonates and especially potassium carbonate, and
f) water up to the total volume of the formulation and where the amount of water is in particular as given above.

More particularly, the groups (3), (3a) and (3b) of embodiments relate to aqueous formulations of dicamba, in particular aqueous SL-formulations which contain
a) 450 to 1000 g/l, in particular in the range of 500 to 975 g/l and especially in the range of 520 to 810 g/l, based on the total volume of the formulation, of a dicamba salt with a water-miscible amine, where the dicamba contains one or more of the aforementioned secondary product in a relative amount with respect to dicamba in the range of 1 wt % to 20 wt %, in particular in the range of 1.5 wt % to 15 wt % and especially in the range of 2 wt % to 10 wt %;
b) 10 to 200 g/l, in particular 20 to 100 g/l and especially 25 to 60 g/l of at least one organic solvent b), which is selected from N—C₂-C₁₅-alkyl pyrrolidones, wherein the alkyl radical may carry a hydroxyl group, where the solvent b) is preferably selected from the group consisting of N—C₃-C₁₂-alkyl pyrrolidones and more particularly from the group of N—C₃-C₈-alkyl pyrrolidones and where especially the solvent b) comprises or is N-(n-butyl) pyrrolidone;
c) optionally 50 to 300 g/l, in particular 80 to 200 g/l, especially 110 to 170 g/l of an inorganic buffer preferably selected from alkalimetal carbonates and especially potassium carbonate, and
f) water up to the total volume of the formulation and where the amount of water is in particular as given above.

Especially, the groups (3), (3a) and (3b) of embodiments relate to aqueous formulations of dicamba, in particular aqueous SL-formulations which contain
a) 450 to 1000 g/l, in particular in the range of 500 to 975 g/l and especially in the range of 520 to 810 g/l, based on the total volume of the formulation, of a dicamba salt with a water-miscible amine, where the dicamba contains one or more of the aforementioned secondary product in a relative amount with respect to dicamba in the range of 1 wt % to 20 wt %, in particular in the range of 1.5 wt % to 15 wt % and especially in the range of 2 wt % to 10 wt %;
b) 10 to 200 g/l, in particular 20 to 100 g/l and especially 25 to 60 g/l of at least one organic solvent b) which is selected from the solvents of group (1) of embodiments, wherein the solvent b) is selected from N—C₃-C₆-alkyl pyrrolidones, where the alkyl radical is linear, more particularly from N—C₄-C₅-alkyl pyrrolidones, where the alkyl radical is linear, and especially the solvent b) is N-(n-butyl) pyrrolidone;
c) 50 to 300 g/l, in particular 80 to 200 g/l, especially 110 to 170 g/l of an inorganic buffer, which is preferably selected from alkalimetal carbonates and especially potassium carbonate,
f) water up to the total volume of the formulation and where the amount of water is in particular as given above.

Usually, the formulations of group (3) of embodiments will have a pH in the range of pH 6.0 to pH 11.0, in particular in the range of pH 6.5 to pH 10.5 or in the range of pH 7.0 to pH 10.2, as determined at 22° C. and 1 bar in the undiluted aqueous formulation by means of a glass electrode.

A group 4 of embodiments relates to aqueous formulations, where the dicamba-salt is a salt of dicamba with potassium. These salts are hereinafter abbreviated as dicamba-K.

Dicamba-K is commercially available. It can be prepared by reaction of the free acid form of dicamba with KOH. Dicamba-K typically refers to a 1:1 salt of the dicamba anion and potassium.

The above disclosure with regard to the type of component b), its amounts, the concentrations of dicamba salt, the type and amount of secondary components and the amount of water apply to the groups 4 of embodiments, if not stated otherwise.

Usually, the formulations of group 4 of embodiments will have a pH in the range of pH 6.0 to pH 11.0, in particular in the range of pH 6.5 to pH 10.5 or in the range of pH 7.0 to pH 10.2, as determined at 22° C. and 1 bar in the undiluted aqueous formulation by means of a glass electrode.

As a further component, the aqueous formulation of the present invention may contain a further component which is selected from the additives d1) and d2) or a combination thereof and solvents e) selected from C₁-C₆-alkyl lactates and C₃-C₆-lactones. In particular, the formulations of group (4) of embodiments may contain a further component which is selected from the additives d1) and d2) or a combination thereof and solvents e) selected from C₁-C₆-alkyl lactates and C₃-C₆-lactones.

Additives d1) are commercially available. Typical products are products of the products series Pluriol E, Pluronic PE, Genapol PF, and Synperonic PE. Additives d1) can be prepared by reaction of ethylene oxide and propylene oxide in a non-aqueous solvent by a ring-opening reaction. Typically, additives d1) are prepared in two steps. In the first step, propylene glycol or dipropylene glycol is dissolved in a non-aqueous organic solvent, e.g. petrol ether, and propylene oxide is added either as a gas or as a liquid. Optionally, a catalyst is added to the reaction mixture to increase the reaction yield and dispersity of the reaction product. In the second step, ethylene oxide is added to the reaction mixture to yield the final additive of formula d1).

In one embodiment, R¹ and R² in formula (I) are H. In another embodiment, R¹ and R² in formula 1 are C₁-C₃-alkyl. In another embodiment, R¹ and R² in formula (I) are CH₃.

The ratio of (n+p)/m in formula (I) is typically at least 1:1, preferably at least 3:2. The ratio (n+p)/m in formula (I) is typically up to 10:1, preferably up to 8:1, more preferably up to 6:1.

The ratio of (n+p)/m in formula (I) is typically at from 1:1 to 10:1, preferably from 1:1 to 9:1, more preferably from 3:2 to 7:1.

In a first embodiment PA-1 of additive d1), the indices n and p in formula (I) are each independently 20 to 100, preferably 30 to 80, more preferably 40 to 70, most preferably 40 to 60, and particularly preferably 45 to 55. In this same embodiment PA-1, the index m in formula (I) is from 20 to 100, preferably 30 to 80, more preferably 40 to 70, most preferably 50 to 60.

In a second embodiment PA-2 of additive d1), the indices n and p in formula (I) are each independently 50 to 100, preferably 60 to 80, more preferably 65 to 75. In this same embodiment PA-2, the index m in formula (I) is from 10 to 60, preferably 15 to 40, more preferably 20 to 40, most preferably 25 to 35.

Typically, the mass average molecular weight of additive d1) is from 1000 g/ml to 10000 g/ml, preferably 2000 g/mol to 9000 g/mol. In case of embodiment PA-1, the mass average molecular weight of additive d1) is typically from 4000 g/mol to 8000 g/mol, preferably from 5000 g/mol to 7000 g/mol, more preferably from 5500 g/mol to 6500 g/mol. In case of embodiment PA-2, the mass average molecular weight of additive d1) is typically from 5000 g/mol to 10000 g/mol, preferably from 6000 g/mol to 9000 g/mol, more preferably from 7000 g/mol to 9000 g/mol, and particularly preferably from 7500 g/mol to 8500 g/mol.

The formulation of the invention, in particular the formulation of group 4 of embodiments, may contain the additive d1) in a concentration of at least 1 wt %, preferably at least 3 wt %, more preferably at least 4 wt %, and particularly preferably at least 5 wt % based on the total weight of the aqueous formulation. The aqueous formulation of the invention, in particular the formulation of group 4 of embodiments, may contain the additive d1) in a concentration of up to 50 wt %, preferably up to 40 wt %, more preferably up to 30 wt %, most preferably up to 20 wt %, particularly preferably up to 10 wt %, and utmost preferably up to 5 wt % based on the total weight to the aqueous formulation. The aqueous formulation of the invention, in particular the formulation of group 4 of embodiments, may comprise the additive d1) in a concentration of from 1 to 25 wt %, preferably from 2 to 15 wt %, more preferably from 5 to 10 wt %, and particularly preferably from 4 to 6 wt %. Typically, additive d1) is completely dissolved in the formulation of the invention at 20° C.

Additive d2) is a hyperbranched polycarbonate. The term “hyperbranched polycarbonate” means non-crosslinked polycarbonate macromolecules having hydroxyl and carbonate or carbamoyl chloride groups, which may be both structurally and molecularly nonuniform. On the one hand, they may be synthesized starting from a central molecule in the same way as for dendrimers but, in contrast to the latter, with a nonuniform chain length of the branches. Hyperbranched polymers are therefore to be differentiated from dendrimers (U.S. Pat. No. 6,399,048). For the purposes of the present invention, hyperbranched polymers do not comprise dendrimers. On the other hand, the hyperbranched polymers may also be of linear construction, with functional, branched side groups, or else, as a combination of the two extremes, may include linear and branched molecule moieties. For the definition of dendrimers and hyperbranched polymers see also P. J. Flory, J. Am. Chem. Soc. 1952, 74, 2718 and H. Frey et al., Chem. Eur. J. 2000, 6, 2499.

By “hyperbranched” in the context of the present invention is meant that the degree of branching (DB), in other words the ratio of the sum of the average number of dendritic linkages plus the average number of end groups to the sum of the average number of dendritic and linear linkages plus the average number of end groups, per molecule, multiplied by 100, is 10% to 99.9%, preferably 20% to 99%, more preferably 20% to 95%. By “dendrimeric” in the context of the present invention is meant that the degree of branching is 99.9%-100%. For the definition of the degree of branching see H. Frey et al., Acta Polym. 1997, 48, 30.

It is an advantage of the present invention that the additive d2) is a non-crosslinked polymer. “Non-crosslinked” for the purposes of this specification means that the degree of cross-linking present is less than 15% by weight, preferably less than 10% by weight, determined via the insoluble fraction of the polymer. The insoluble fraction of the polymer can be determined by four-hour extraction with the same solvent as used for the gel permeation chromatography for determining the molecular weight distribution of the polymers, i.e., tetrahydrofuran, dimethylacetamide or hexafluoroisopropanol, according to which solvent has the better solvency for the polymer, in a Soxhlet apparatus and, after drying of the residue to constant weight, by weighing of the residue remaining.

The hyperbranched polycarbonate is typically obtainable by
a) preparing a condensation product (K) by reacting an organic carbonate (E) or a phosgene derivative with an alcohol (F1) which has at least three hydroxyl groups, and
b) intermolecularly converting K to the hyperbranched polycarbonate, the quantitative ratio of the OH groups to the carbonate or phosgene groups being selected such that K has an average of either i) one carbonate or carbamoyl chloride group and more than one OH group, or ii) one OH group and more than one carbonate or carbamoyl group. The polycarbonate is preferably obtained in this way.

The condensation product (K) can be prepared using an organic carbonate (E) or a phosgene derivative. Examples of suitable phosgene derivatives are phosgene, diphosgene or triphosgene, preferably phosgene. It is preferred to use an organic carbonate.

The radicals R³ in the organic carbonates (E) of the general formula R³O[(CO)O]ₒR³ that are used as starting material are each independently of one another a straight-chain or branched aliphatic, aromatic/aliphatic (araliphatic) or aromatic hydrocarbon radical having 1 to 20 C atoms. The two radicals R³ may also be joined to one another to form a ring. The two radicals R³ may be the same or different; they are preferably the same. The radical in question is preferably an aliphatic hydrocarbon radical and more preferably a straight-chain or branched alkyl radical having 1 to 5 C atoms, or a substituted or unsubstituted phenyl radical. R³ in this case is a straight-chain or branched, preferably straight-chain (cyclo)aliphatic, aromatic/aliphatic or aromatic, preferably (cyclo)aliphatic or aromatic, more preferably aliphatic hydrocarbon radical having 1 to 20 C atoms, preferably 1 to 12, more preferably 1 to 6, and very preferably 1 to 4 carbon atoms. Examples of such radicals are methyl, ethyl, isopropyl, n-propyl, n-butyl, isobutyl, sec-butyl, tert-butyl, n-hexyl, n-heptyl, n-octyl, n-decyl, n-dodecyl, n-tetradecyl, n-hexadecyl, n-octadecyl, n-eicosyl, 2-ethylhexyl, cyclopentyl, cyclohexyl, cy-clooctyl, cyclododecyl, phenyl, o- or p-tolyl or naphthyl. Methyl, ethyl, n-butyl, and phenyl are preferred. These radicals R³ may be the same or different; they are preferably the same. The radicals R³ may also be joined to one another to form a ring. Examples of divalent radicals R³ of this kind are 1,2-ethylene, 1,2-propylene, and 1,3-propylene. In general, the index o is an integer from 1 to 5, preferably from 1 to 3, more preferably from 1 to 2. The carbonates may preferably be simple carbonates of the general formula R³O(CO)OR³, i.e. the index o in this case is 1.

Examples of suitable carbonates comprise aliphatic, aromatic/aliphatic or aromatic carbonates such as ethylene carbonate, 1,2- or 1,3-propylene carbonate, diphenyl carbonate, ditolyl carbonate, dixylyl carbonate, dinaphthyl carbonate, ethyl phenyl carbonate, dibenzyl carbonate, dimethyl carbonate, diethyl carbonate, di-n-propyl carbonate, di-n-butyl carbonate, diisobutyl carbonate, dipentyl carbonate, dihexyl carbonate, dicyclohexyl carbonate, diheptyl carbonate, dioctyl carbonate, didecyl carbonate or didodecyl carbonate. Examples of carbonates in which n is greater than 1 comprise dialkyl dicarbonates, such as di-tert-butyl dicarbonate, or dialkyl tricarbonates such as di-tert-butyl tricarbonate. One preferred aromatic carbonate is diphenyl carbonate. Preference is given to aliphatic carbonates, more particularly those in which the radicals comprise 1 to 5 C atoms, such as dimethyl carbonate, diethyl carbonate, di-n-propyl carbonate, di-n-butyl carbonate or diisobutyl carbonate, for example. Diethyl carbonate is especially preferred.

The alcohol (F1) which has at least three hydroxyl groups is usually an aliphatic or aromatic alcohol, or a mixture or two or more different alcohols of this kind. The alcohol (F1) may be branched or unbranched, substituted or unsubstituted, and have 3 to 26 carbon atoms. It is preferably an aliphatic alcohol. Examples of compounds having at least three OH groups comprise glycerol, trimethylolmethane, trimethylolethane, trimethylolpropane, trimethylolbutane, 1,2,4-butanetriol, 1,2,3-hexanetriol, 1,2,4-hexanetriol, tris(hydroxymethyl)amine, tris(hydroxyethyl)amine, tris(hydroxypropyl)amine, pentaerythritol, diglycerol, triglycerol, poly-glycerols, bis(trimethylolpropane), tris(hydroxymethyl) isocyanurate, tris(hydroxyethyl) isocyanurate, phloroglucinol, trihydroxytoluene, trihydroxydimethylbenzene, phloroglucides, hexahydroxybenzene, 1,3,5-benzenetrimethanol, 1,1,1-tris(4′-hydroxyphenyl)methane, 1,1,1-tris(4′-hydroxyphenyl)ethane, sugars, for example glucose, sugar derivatives, for example sorbitol, mannitol, diglycerol, threitol, erythritol, adonitol (ribitol), arabitol (lyxitol), xylitol, dulcitol (galactitol), maltitol, isomalt, or polyesterol. In addition, F1 may be a trifunctional or higher-functionality polyetherol based on alcohols which have at least three OH groups, and C₂-C₂₄ alkylene oxide. The polyetherol comprises usually one to 30, preferably one to 20, more preferably one to 10 and most preferably one to eight molecules of ethylene oxide and/or propylene oxide and/or isobutylene oxide per hydroxyl group. Preferably, the polyetherol is based on an alcohol with at least 3 OH groups and 1 to 30 molecules alkylene oxide, more preferably based on an alcohol with at least 3 OH groups and 5 to 20 molecules propylene oxide.

The hyperbranched polycarbonate preferably comprises an alcohol (F1) which is a trifunctional or higher-functionality polyetherol based on alcohols which have at least three OH groups, and C₃-C₂₄ alkylene oxide. Suitable alcohols which have at least three OH groups are as described above, preferably glycerol, trimethylolethane, trimethylolpropane, 1,2,4-butanetriol, 1,2,3-hexanetriol, 1,2,4-hexanetriol, pentaerythritol, more preferably glycerol or trimethylolpropane. Preferred C₃-C₂₄ alkylene oxides include propylene oxide, butylene oxide, pentylene oxide and mixtures thereof, more preferably propylene oxide. The trifunctional or higher-functionality polyetherols usually comprise at least one to 30, preferably two to 30, more preferably three to 20 C₃-C₂₄ alkylene oxide molecules in polymerized form. A particularly preferred alcohol (F1) is a trifunctional polyetherol based on glycerol, trimethylolethane, trimethylolpropane, 1,2,4-butanetriol and/or pentaerythritol, and propylene oxide, where the polyetherol comprises at least three, preferably three to 30, more preferably three to 20, molecules of propylene oxide in polymerized form.

In addition to the alcohol (F1), the polycarbonate may have a difunctional alcohol (F2) as a forming component, with the proviso that the mean OH functionality of all alcohols F used together is greater than 2. The alcohols (F1) and (F2) are referred to here together as (F).

Suitable difunctional alcohols F2 include diethylene glycol, triethylene glycol, 1,2- and 1,3-propanediol, dipropylene glycol, tripropylene glycol, neopentyl glycol, 1,2-, 1,3- and 1,4-butanediol, 1,2-, 1,3- and 1,5-pentanediol, 1,6-hexanediol, 1,2- or 1,3-cyclopentanediol, 1,2-, 1,3- or 1,4-cyclohexanediol, 1,1-, 1,2-, 1,3- or 1,4-cyclohexanedimethanol, bis(4-hydroxycyclohexyl)methane, bis(4-hydroxycyclohexyl)ethane, 2,2-bis(4-hydroxycyclohexyl)propane, 1,1′-bis(4-hydroxyphenyl)-3,3,5-trimethylcyclohexane, resorcinol, hydroquinone, 4,4′-dihydroxybiphenyl, bis(4-hydroxyphenyl) sulfide, bis(4-hydroxyphenyl) sulfone, bis(hydroxymethyl)benzene, bis(hydroxymethyl)toluene, bis(p-hydroxyphenyl)methane, bis(p-hydroxyphenyl)ethane, 2,2-bis(p-hydroxyphenyl)propane, 1,1-bis(p-hydroxyphenyl)cyclohexane, dihydroxybenzophenone, difunctional polyetherpolyols based on ethylene oxide, propylene oxide, butylene oxide or mixtures thereof, polytetrahydrofuran having a molar mass of 162 to 2000, polycaprolactone or polyesterols based on diols and dicarboxylic acids. Preferred difunctional alcohols (F2) are difunctional polyetherpolyols based on ethylene oxide, propylene oxide, butylene oxide or mixtures thereof, and polyesterols based on diols and dicarboxylic acids.

The diols serve for fine adjustment of the properties of the polycarbonate. If difunctional alcohols are used, the ratio of difunctional alcohols (F2) to the at least trifunctional alcohols (F1) is fixed by the person skilled in the art according to the desired properties of the polycarbonate. In general, the amount of the alcohol(s) (F2) is 0 to 50 mol % based on the total weight of all alcohols (F1) and (F2) together. The amount is preferably 0 to 35 mol %, more preferably 0 to 25 mol % and most preferably 0 to 10 mol %.

The reaction of phosgene, diphosgene or triphosgene with the alcohol or alcohol mixture is generally effected with elimination of hydrogen chloride; the reaction of the carbonates with the alcohol or alcohol mixture to give the inventive high-functionality highly branched polycarbonate is effected with elimination of the monofunctional alcohol or phenol from the carbonate molecule.

After this reaction, i.e. without any further modification, the hyperbranched polycarbonate has high-functionality termination with hydroxyl groups and with carbonate groups or carbamoyl chloride groups. A high-functionality polycarbonate is understood in the context of this invention to mean a product which, as well as the carbonate groups which form the polymer skeleton, additionally has, in terminal or lateral position, at least three, preferably at least four and more preferably at least six functional groups. The functional groups are carbonate groups or carbamoyl chloride groups and/or OH groups. There is in principle no upper limit in the number of terminal or lateral functional groups, but products with a very high number of functional groups may have undesired properties, for example high viscosity or poor solubility. The high-functionality polycarbonates of the present invention usually have not more than 500 terminal or lateral functional groups, preferably not more than 100 terminal or lateral functional groups.

In the preparation of the high-functionality polycarbonates, it is necessary to adjust the ratio of the compounds comprising OH groups to phosgene or carbonate (A) such that the resulting simplest condensation product (known hereinafter as condensation product (K)) comprises an average of either i) one carbonate or carbamoyl chloride group and more than one OH group or ii) one OH group and more than one carbonate or carbamoyl chloride group, preferably an average of either i) one carbonate or carbamoyl chloride group and at least two OH groups or ii) one OH group and at least two carbonate or carbamoyl chloride groups.

It may additionally be advisable, for fine adjustment of the properties of the polycarbonate, to use at least one difunctional carbonyl-reactive compound (E1). This is understood to mean those compounds which have two carbonate and/or carboxyl groups. Carboxyl groups may be carboxylic acids, carbonyl chlorides, carboxylic anhydrides or carboxylic esters, preferably carboxylic anhydrides or carboxylic esters and more preferably carboxylic esters. If such difunctional compounds (E1) are used, the ratio of (E1) to the carbonates or phosgenes (E) is fixed by the person skilled in the art according to the desired properties of the polycarbonate. In general, the amount of the difunctional compound(s) (E1) is 0 to 40 mol % based on the total weight of all carbonates/phosgenes (E) and compounds (E1) together. Preferably the amount is 0 to 35 mol %, more preferably 0 to 25 mol %, and very preferably 0 to 10 mol %. Examples of compounds (E1) are dicarbonates or dicarbamoyl chlorides of diols, examples of which are ethylene glycol, 1,2-propanediol, 1,3-propanediol, 1,1-dimethyl-ethane-1,2-diol, 2-butyl-2-ethyl-1,3-propanediol, 2-ethyl-1,3-propanediol, 2-methyl-1,3-propanediol, neopentyl glycol, neopentyl glycol hydroxypivalate, 1,2-, 1,3- or 1,4-butanediol, 1,6-hexanediol, 1,10-decanediol, bis(4-hydroxycyclohexane)isopropylidene, tetramethylcyclo-butanediol, 1,2-, 1,3- or 1,4-cyclohexanediol, cyclooctanediol, norbornanediol, pinanediol, decalindiol, 2-ethyl-1,3-hexanediol, 2,4-diethyloctane-1,3-diol, hydroquinone, bisphenol A, bisphenol F, bisphenol B, bisphenol S, 2,2-bis(4-hydroxycyclohexyl)propane, 1,1-, 1,2-, 1,3- and 1,4-cyclohexanedimethanol, and 1,2-, 1,3- or 1,4-cyclohexanediol. These compounds may be prepared, for example, by reacting said diols with an excess of, for example, the above-recited carbonates R³O(CO)OR³ or chlorocarbonic esters, so that the dicarbonates thus obtained are substituted on both sides by groups R³O(CO)—. A further possibility is to react the diols first with phosgene to give the corresponding chlorocarbonic esters of the diols, and then to react these esters with alcohols.

Further compounds (E1) are dicarboxylic acids, esters of dicarboxylic acids, preferably the methyl, ethyl, isopropyl, n-propyl, n-butyl, isobutyl, sec-butyl or tert-butyl esters, more preferably the methyl, ethyl or n-butyl esters. Examples of dicarboxylic acids of this kind are oxalic acid, maleic acid, fumaric acid, succinic acid, glutaric acid, adipic acid, sebacic acid, dodecanedioic acid, o-phthalic acid, isophthalic acid, terephthalic acid, azelaic acid, 1,4-cyclohexane-dicarboxylic acid or tetrahydrophthalic acid, suberic acid, phthalic anhydride, tetrahydrophthalic anhydride, hexahydrophthalic anhydride, tetrachlorophthalic anhydride, endomethylenetet-rahydrophthalic anhydride, glutaric anhydride, dimeric fatty acids, isomers thereof and hydrogenation products thereof.

The most simple structure of the condensation product (K), illustrated using, as example, the reaction of a carbonate (E) with a dialcohol or polyalcohol (F), produces the arrangement XY_{q} or Y_{q}X, wherein X is a carbonate or carbamoyl group, Y is a hydroxyl group, and the index q generally is an integer greater than 1 to 6, preferably greater than 1 to 4, more preferably greater than 1 to 3. The reactive group, which results as a single group, is generally referred to below as “focal group”.

Where, for example, in the preparation of the simplest condensation product (K) from a carbonate and a dihydric alcohol, the molar reaction ratio is 1:1, then the result on average is a molecule of type XY, illustrated by the general formula (II).

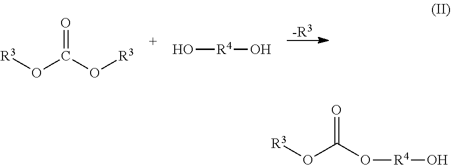

In the case of the preparation of the condensation product (K) from a carbonate and a trihydric alcohol with a molar reaction ratio of 1:1, the result on average is a molecule of type XY₂, illustrated by the general formula (III). The focal group here is a carbonate group.

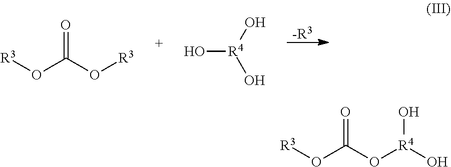

In the preparation of the condensation product (K) from a carbonate and a tetrahydric alcohol, again with the molar reaction ratio 1:1, the result on average is a molecule of type XY₃, illustrated by the general formula (IV). The focal group here is a carbonate group.

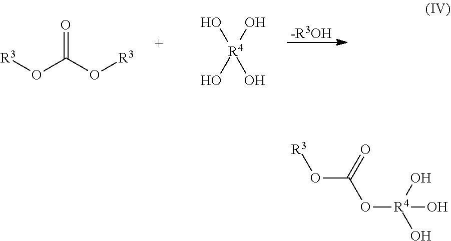

In the formulae (II) to (IV) R³ is as defined for the organic carbonate (E), and R⁴ is an aliphatic or aromatic radical.

The condensation product (K) can also be prepared, for example, from a carbonate and a trihydric alcohol, illustrated by the general formula (V), where the reaction ratio on a molar basis is 2:1. Here the result on average is a molecule of type X₂Y, the focal group here being an OH group. In the formula (V) the definitions of R³ and R⁴ are the same as above in formulae (II) to (IV).

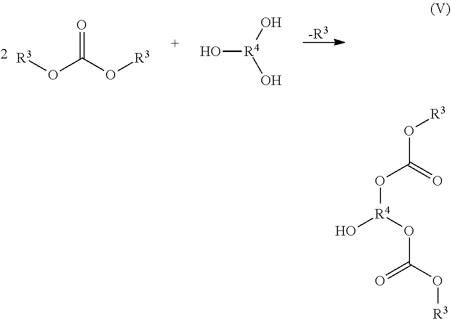

If difunctional compounds, e.g., a dicarbonate or a diol, are additionally added to the components, this produces an extension of the chains, as illustrated for example in the general formula (VI). The results again is on average a molecule of type XY₂, the focal group being a carbonate group.

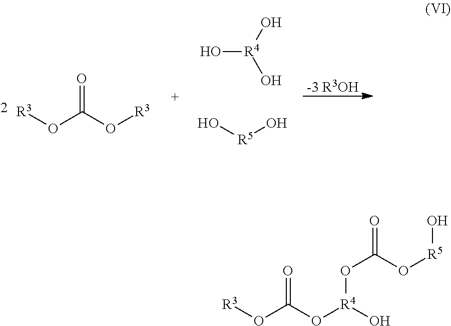

In formula (VI) R⁵ is an aliphatic or aromatic radical while R³ and R⁴ are defined as described above.

It is also possible to use two or more condensation products (K) for the synthesis. In this case, it is possible on the one hand to use two or more alcohols and/or two or more carbonates. Furthermore, through the choice of the ratio of the alcohols and carbonates or phosgenes used, it is possible to obtain mixtures of different condensation products with different structure. This may be exemplified taking, as example, the reaction of a carbonate with a trihydric alcohol. If the starting products are used in a 1:1 ratio, as depicted in (Ill), a molecule XY₂ is obtained. If the starting products are used in a 2:1 ratio, as illustrated in (V), the result is a molecule X₂Y. With a ratio between 1:1 and 2:1 a mixture of molecules XY₂ and X₂Y is obtained.

The stoichiometry of components (E) and (F) is generally chosen such that the resultant condensation product (K) contains either one carbonate or carbamoyl chloride group and more than one OH group, or one OH group and more than one carbonate or carbamoyl chloride group. This is achieved in the first case by a stoichiometry of 1 mol of carbonate groups: >2 mol of OH groups, for example, a stoichiometry of 1:2.1 to 8, preferably 1:2.2 to 6, more preferably 1:2.5 to 4, and very preferably 1:2.8 to 3.5. In the second case it is achieved by a stoichiometry of more than 1 mol of carbonate groups: <1 mol of OH groups, for example, a stoichiometry of 1:0.1 to 0.48, preferably 1:0.15 to 0.45, more preferably 1:0.25 to 0.4, and very preferably 1:0.28 to 0.35.

The preparation of additive d2) is described in WO2010/130599, particularly preferably p.13, I.5 to p.16, I.25 and the Synthesis Examples.

The hyperbranched polycarbonate generally has a glass transition temperature of less than 50° C., preferably less than 30° C. and more preferably less than 10° C. The OH number is usually at least 30 mg KOH/g, preferably between 50 and 250 mg/g. The mass average molar weight MW is usually between 1000 and 150 000, preferably from 1500 to 100 000 g/mol, the number average molar weight Mn between 500 and 50 000, preferably between 1000 and 40 000 g/mol.

The hyperbranched polycarbonate is connected to a linear polymer comprising polyethylene glycol. Examples of polyethylene glycol are polyethylene glycol or polyethylene glycol monoalkyl ethers having a number average molar mass Mn of 200 to 10000 g/mol, preferably 300-2000 g/mol. The polyethylene glycol is preferably a polyethyleneglycol mono-C₁-C₁₅-alkyl ether, especially a polyethylene glycol monomethyl ether. The molar ratio of hyperbranched polycarbonate to linear polymer is usually in the range from 1:1 to 1:100, preferably 1:1 to 1:50, more preferably 1:1 to 1:25.

Typically, the linear polymer is joined to the polycarbonate via a linker. Suitable functionalizing reagents for covalent joining by means of a linker are hydroxycarboxylic acids, aminocarboxylic acids, hydroxysulfonic acids, hydroxysulfates, aminosulfonic acids or aminosulfates, hydroxylamines (such as diethanolamine), polyamines (e.g. diethylenetetramine) or polyols (e.g. glycerol, trimethylolpropane, pentaerythritol). Preferred linkers for this purpose are polyisocyanates described below, preferably diisocyanates, more preferably aliphatic diisocyanates (such as hexamethylene diisocyanate and isophorone diisocyanate).

Preferred diisocyanates are aliphatic diisocyanates (such as hexamethylene diisocyanate and isophorone diisocyanate). Usually, the linker is first bonded covalently to a terminal OH-group of the linear polymer, in order then to couple the linker-containing polymer onto the hyperbranched polycarbonate. The reaction of the linear polymer with a diisocyanate is described in WO2010/130599, p.23, I.33 to p.24, I.42.

Alternatively, the linear polymer may be generated by direct alkoxylation of the polycarbonate, as described in WO2011069895. The direct alkoxylation may be carried out by reaction with ethylene oxide or a mixture of ethylene oxide and C₃-C₅ alkylene oxide. If the alcohol (F1) is higher-functionality polyetherol based on alcohols which have at least three OH groups, and C₃-C₂₄ alkylene oxide, the weight ratio of the oligo- or polymerized C₃-C₂₄ alkylene oxide plus the C₃-C₅ alkylene oxide, relative to the ethylene oxide is from 3:1 to 1:3.

The molar ratio of hyperbranched polycarbonate to linear polymer is 1:1 to 1:25, preferably 1:2 to 1:15. The reaction is continued until the isocyanate value has fallen to zero.

Additives d1) and d2) contain certain monomers in polymerized form. Although trace amounts of unreacted monomers may still be present in the polymers, they are essentially free of monomers. Throughout this specification, the terms “contains monomers [x] in polymerized form” and “contains monomers [x]” have the same meaning.

The aqueous formulation of the invention may contain the additive d2) in a concentration of at least 0.5 wt %, preferably at least 1 wt %, more preferably at least 2 wt % based on the total weight of the agrochemical composition. The aqueous formulation of the invention may contain the additive d2) in a concentration of up to 30 wt %, preferably up to 25 wt %, more preferably up to 20 wt %, most preferably up to 18 wt %, and particularly preferably up to 17.5 wt % based on the total weigh to the agrochemical composition. The aqueous formulation of the invention, in particular the formulation of group 4 of embodiments, may comprise the additive d2) in a concentration of from 0.5 to 25 wt %, preferably from 1 to 25 wt %, more preferably from 1 to 20 wt %, most preferably from 2 to 20 wt % based on the total weight of the aqueous formulation.

The aqueous formulation of the invention, in particular the formulation of group 4 of embodiments, may contain the additive d2) in a concentration of at least 5 g/l, preferably at least 10 g/l, more preferably at least 25 g/l. The aqueous formulation of the invention may comprise the additive d2) in a concentration of up to 350 g/l, preferably up to 300 g/l, more preferably up to 250 g/l. The aqueous formulation of the invention may contain the additive d2) in a concentration of from 1 to 350 g/l, preferably from 5 to 250 g/l, more preferably from 25 to 250 g/l.

Typically, additive d2) is completely dissolved in the aqueous formulation of the invention at 20° C.

The aqueous formulations of the present invention, in particular the formulations of group 4 of embodiments, may further contain a solvent selected from C₁-C₆-alkyl lactates and C₃-C₆-lactones, and combinations thereof as component e). The terms component e) and solvent e) are used synonymously.

In one embodiment, the aqueous formulations of the invention, in particular the formulations of group 4 of embodiments, contain a solvent selected from C₁-C₆-alkyl lactates, preferably C₁-C₃-alkyl lactates, more preferably ethyl lactate or n-propyl lactate. In one embodiment, the solvent is selected from methyl lactate, ethyl lactate, propyl lactate, butyl lactate, pentyl lactate, and hexyl lactate. In another embodiment, the solvent is ethyl lactate. In another embodiment, the solvent is n-propyl lactate. In another embodiment, the solvent is methyl lactate.

In another embodiment, the solvent is pentyl lactate. In another embodiment, the solvent is hexyl lactate.

In another preferred group embodiments, the aqueous formulations of the invention, in particular the formulations of group 4 of embodiments, contain a solvent e) selected from C₃-C₆-lactones, preferably C₄-C₅-lactones. In one embodiment, the solvent e) is gamma-butyrolactone. In another embodiment, the solvent e) is epsilon-caprolactone. In another embodiment, the solvent e) is beta-propiolactone.

The aqueous formulations of the invention, in particular the formulations of group 4 of embodiments, may contain the solvent e) in a concentration in a concentration in the range of 1 to 25 wt %, in particular in the range of 1 to 20 wt %, preferably in the range of 1 to 18 wt %, and in the range of 2 to 17 wt %, based on the total weight of the formulation.

If no other additive d1) or d2) are present in the aqueous formulation of the invention, the total concentration of solvents b) and e) is typically at least 2 wt %, preferably at least 2.5 wt %, more preferably at least 3 wt %, most preferably at least 4 wt %, based on the total weight of the aqueous formulation of the invention. If no other additive d1) or d2) is present in the aqueous formulation of the invention, the total concentration of solvents b) and e) is typically from 2 to 25 wt %, more preferably from 3 to 20 wt %, most preferably from 4 to 18 wt % based on the total weight of the aqueous formulation of the invention.

Accordingly, if no other additive d1) or d2) is present in the aqueous formulation of the invention, the total concentration of solvents b) and e) is typically at least 15 g/l, preferably at least 20 g/l, more preferably at least 25 g/l. If no other additive d1) or d2) is present in the aqueous formulation of the invention, the total concentration of solvents b) and e) is typically in the range of 10 to 250 g/l in particular in the range of 15 to 200 g/l, especially 20 to 180 g/l, based on the total volume of the formulation.

In a particular group of embodiments, in particular in a subgroup of group 4 of embodiments, the solvent e) is a C₃-C₆-lactone, preferably gamma butyrolactone. In this group of embodiments, the concentration of the solvent c) is typically at least 10 g/l, preferably at least 20 g/l, more preferably at least 25 g/l, most preferably at least 50 g/l, utmost preferably at least 80 g/l; and the concentration is of adjuvant e) is up to 300 g/l, preferably up to 250 g/l, more preferably up to 200 g/l, based on the total volume of the aqueous formulation.

In another group of embodiments the aqueous formulations of the invention, in particular the formulations of groups 3, 3a and 3b of embodiments, do not contain a solvent e) or not more than 80 g/l, in particular not more than 50 g/l, preferably not more than 10 g/l, and especially not more than 1 g/l of solvent e), based on the total volume of the aqueous formulation.

In another group of embodiments the aqueous formulation of the invention, in particular the formulations of groups 3, 3a and 3b of embodiments, do not contain an d) or or not more than 10 g/l, in particular not more than 5 g/l, preferably not more than 2 g/l, and especially not more than 1 g/l of additive d), based on the total volume of the aqueous formulation.

In another group of embodiments the aqueous formulation of the invention does not contain gamma butyrolactone or not more than 80 g/l, in particular not more than 50 g/l, preferably not more than 10 g/l, and especially not more than 1 g/l of gamma butyrolactone, based on the total volume of the aqueous formulation.

In one embodiment, the aqueous formulation of the invention comprises dicamba-K, N—C₁-C₁₅-alkyl pyrrolidone, and additive d1). In another embodiment, the aqueous formulation of the invention comprises dicamba-K, N-octyl pyrrolidone, and additive d1), preferably wherein additive d1) is as defined in embodiments PA-1 or PA-2, more preferably wherein additive d1) is as defined in embodiment PA-2. In another embodiment, the aqueous formulation of the invention comprises dicamba-K, N-butyl pyrrolidone, and additive d1), preferably wherein additive d1) is as defined in embodiments PA-1 or PA-2, more preferably wherein additive d1) is as defined in embodiment PA-2. In another embodiment, the aqueous formulation of the invention comprises dicamba-K, N-dodecyl pyrrolidone, and additive d1), preferably wherein additive d1) is as defined in embodiments PA-1 or PA-2, more preferably wherein additive d1) is as defined in embodiment PA-2.

In one embodiment, the aqueous formulation of the invention comprises dicamba-K, solvent b), C₃-C₆-lactone, and additive d1). In another embodiment, the aqueous formulation of the invention comprises dicamba-K, solvent b), gamma-butyrolactone, and additive d1), preferably wherein additive d1) is as defined in embodiments PA-1 or PA-2, more preferably wherein additive d1) is as defined in embodiment PA-2. In another embodiment, the aqueous formulation of the invention comprises dicamba-K, solvent b), epsilon-caprolactone, and additive d1), preferably wherein additive d1) is as defined in embodiments PA-1 or PA-2, more preferably wherein additive d1) is as defined in embodiment PA-2.

In one embodiment, the aqueous formulation of the invention comprises dicamba-K, N—C₁-C₁₅-alkyl pyrrolidone, and additive d2). In another embodiment, the aqueous formulation of the invention comprises dicamba-K, N-octyl pyrrolidone, and additive d2), wherein additive d2) is preferably a hyperbranched polycarbonate connected to a polyethylene glycol moo-C₁-C₁₈-alkyl ether, more preferably wherein the hyperbranched polycarbonate is connected to a polyethylene glycol monomethyl ether, most preferably wherein additive d2) a hyperbranched polycarbonate connected to polyethylene glycol monomethyl ether via a linker.

In another embodiment, the aqueous formulation of the invention comprises dicamba-K, N-butyl pyrrolidone, and additive d2), wherein additive d2) is preferably a hyperbranched polycarbonate connected to a polyethylene glycol moo-C₁-C₁₈-alkyl ether, more preferably wherein the hyperbranched polycarbonate is connected to a polyethylene glycol monomethyl ether, most preferably wherein additive d2) a hyperbranched polycarbonate connected to polyethylene glycol monomethyl ether via a linker.

In another embodiment, the aqueous formulation of the invention comprises dicamba-K, N-dodecyl pyrrolidone, and additive d2), wherein additive d2) is preferably a hyperbranched polycarbonate connected to a polyethylene glycol moo-C₁-C₁₈-alkyl ether, more preferably wherein the hyperbranched polycarbonate is connected to a polyethylene glycol monomethyl ether, most preferably wherein additive d2) a hyperbranched polycarbonate connected to polyethylene glycol monomethyl ether via a linker.

In another embodiment, the aqueous formulation of the invention comprises dicamba-K, solvent b), C₃-C₆-lactone, and additive d2), wherein additive d2) is preferably a hyperbranched polycarbonate connected to a polyethylene glycol moo-C₁-C₁₈-alkyl ether, more preferably wherein the hyperbranched polycarbonate is connected to a polyethylene glycol monomethyl ether, most preferably wherein additive d2) a hyperbranched polycarbonate connected to polyethylene glycol monomethyl ether via a linker.

In another embodiment, the aqueous formulation of the invention comprises dicamba-K, solvent b), gamma-butyrolactone, and additive d2), wherein additive d2) is preferably a hyperbranched polycarbonate connected to a polyethylene glycol moo-C₁-C₁₈-alkyl ether, more preferably wherein the hyperbranched polycarbonate is connected to a polyethylene glycol monomethyl ether, most preferably wherein additive d2) a hyperbranched polycarbonate connected to polyethylene glycol monomethyl ether via a linker.

If the formulation of the invention contains a solvent e), in particular a C₃-C₆-lactone, the weight ratio of solvent e) to solvent b) N—C₂-C₁₅-alkyl pyrrolidone is frequently in the range of 5:1 to 1:5, in particular in the range of 1:1 to 1:3.

If the aqueous formulations of the invention, in particular the aqueous formulations of group 4 of embodiments contain at least one further component selected from the group consisting of additive d2, additive d2) and solvent e), The total concentration solvent b), additive d2, additive d2) and solvent e) is generally at least 60 g/l, in particular at least 80 g/l and especially at least 100 g/l. The total concentration of concentration solvent b), additive d2, additive d2) and solvent e) may be up to 400 g/l, in particular not more than 250 g/l, especially not more than 230 g/l.

If the formulation contains an additive d1), the weight ratio of additive d2) to the total amount of solvents b) and e) is generally in the range of 20:1 to 1:20, in particular in the range of 10:1 to 1:10, especially in the range of 5:1 to 1:5 or in the range of 2:1 to 1:3.

If the formulation contains an additive d2), the weight ratio of additive d2) to the total amount of solvents b) and e) is generally in the range of 20:1 to 1:20, in particular in the range of 10:1 to 1:10, especially in the range of 8:1 to 1:8.

The aqueous formulation of the invention may contain one or more further co-solvent, which are different from solvents b) and e). Suitable co-solvents are water-miscible up to at least a ratio of the co-solvent to water of 1:1, preferably at least 2:1, more preferably at least 4:1. Suitable co-solvents are alcohols, e.g. ethanol, propanol, butanol, benzyl alcohol, cyclohexanol; glycols; DMSO; ketones, e.g. heptanone, cyclohexanone; esters, e.g. carbonates, fatty acid esters, fatty acids; phosphonates; amines; amides, e.g. fatty acid dimethylamides; and mixtures thereof. The concentration of the co-solvent in the formulation will generally not exceed 5 wt %, in particular 2 wt % or 1 wt %. In particular, the formulations of the invention do not contain a further co-solvent or less than 1 wt % of co-solvent.

The formulations of the present invention can be prepared by analogy to known methods, such as described by Mollet and Grubemann, Formulation technology, Wiley VCH, Weinheim, 2001; or Knowles, New developments in crop protection product formulation, Agrow Reports DS243, T&F Informa, London, 2005. Usually, formulations of the present invention are produced by mixing the dicamba salt with water and at least one solvent b) and optionally any further component contained in the formulation. The mixing of the components may be carried out in any order. Mixing is typically achieved by stirring, shaking, homogenizing and the like. Typically, the dicamba salt is used as an aqueous concentrate obtained from a production site and mixed with the further components in any order.

The aqueous formulation of the invention may be co-formulated with a further pesticide. Therefore, the present invention also relates to co-formulations, wherein a further pesticide is included in a formulation of the present invention.

The term pesticide refers to at least one active substance selected from the group of fungicides, insecticides, nematicides, herbicides, safeners, biopesticides and/or growth regulators. In one embodiment, the pesticide is an insecticide. In another embodiment, the pesticide is a fungicide. In yet another embodiment the pesticide is a herbicide. The skilled worker is familiar with such pesticides, which can be found, for example, in the Pesticide Manual, 16th Ed. (2013), The British Crop Protection Council, London. Suitable insecticides are insecticides from the class of the carbamates, organophosphates, organochlorine insecticides, phenylpyrazoles, pyrethroids, neonicotinoids, spinosins, avermectins, milbemycins, juvenile hormone analogs, alkyl halides, organotin compounds nereistoxin analogs, benzoylureas, diacylhydrazines, METI acarizides, and insecticides such as chloropicrin, pymetrozin, flonicamid, clofentezin, hexythiazox, etoxazole, diafenthiuron, propargite, tetradifon, chlorofenapyr, DNOC, buprofezine, cyromazine, amitraz, hydramethylnon, acequinocyl, fluacrypyrim, rotenone, or their derivatives. Suitable fungicides are fungicides from the classes of dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides, carboxylic acid diamides, chloronitriles cyanoacetamide oximes, cyanoimidazoles, cyclopropanecarboxamides, dicarboximides, dihydrodioxazines, dinitro-phenyl crotonates, dithiocarbamates, dithiolanes, ethylphosphonates, ethylaminothiazolecarboxamides, guanidines, hydroxy-(2-amino)pyrimidines, hydroxyanilides, imidazoles, imidazolinones, inorganic substances, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, triazoles. Suitable herbicides are herbicides from the classes of the acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas. Examples of herbicides are glyphosate, glufosinate, paraquat, diquat, imazamox, 2,4-dichlorophenoxyacetic acid, aminopyralid, clopyralid, fluroxypyr, imazapyr, imazapic, triclopyr, and pyroxasulfone.

In one embodiment, the further pesticide is glyphosate. In yet another embodiment the pesticide is 2,4-dichlorophenoxyacetic acid. In yet another embodiment, the pesticide is pyroxasulfone. In yet another embodiment the pesticide is imazamox. In yet another embodiment, the pesticide is selected from glyphosate, glufosinate, paraquat, diquat, imazamox, 2,4-dichlorophenoxyacetic acid. In yet another embodiment, the pesticide is selected from glyphosate, glufosinate, imazamox, 2,4-dichlorophenoxyacetic acid.

In a particular group of embodiments, the further pesticide is selected from glyphosate, glufosinate, and a mixture thereof.

Preferably, the further pesticide has a water-solubility at 20° C. of at least 10 g/l, in particular at least 50 g/l.

The aqueous co-formulation may comprise the further pesticide in a concentration of at least 10 wt %, preferably at least 20 wt % more preferably at least 30 wt %, more preferably at least 40 wt %, most preferably at least 50 wt %, based on the total weight of the agrochemical composition. The agrochemical composition may comprise the further pesticide in an amount of from 10 to 90 wt %, preferably from 20 to 80 wt %, more preferably from 30 to 70 wt %, based on the total weight of the agrochemical composition.

The ratio of dicamba-salt to the further pesticide may be from 10:1 to 1:10, preferably from 5:1 to 1:5, more preferably from 2:1 to 1:2. The ratio of dicamba-K to the further pesticide may be at least 1:1, preferably at least 3:1, more preferably 4:1.

The co-formulation may further contain one or more conventional auxiliaries depending on the type of co-formulation. Conventional auxiliaries are, liquid carriers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable surfactants include anionic surfactants and non-ionic surfactants. Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignin sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable non-ionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide.

Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable adjuvants are compounds, which have a neglectable or even no pesticidal activity themselves, and which improve the biological performance of dicamba-salts on the target. Examples are surfactants, mineral or vegetable oils, and other auxiliaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), inorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexa-cyanoferrate) and organic colorants (e.g. alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers.

Apart from that, formulations of other pesticides (e.g. herbicides, insecticides, fungicides, growth regulators, safeners) and/or adjuvants and/or further additives, such as fertilizers or micronutrients, may be added to the formulations of the invention immediately prior to use, i.e. as tank mix. These agents can be admixed with the compositions according to the invention in a weight ratio of 1:100 to 100:1, preferably 1:10 to 10:1.

The user applies the formulations according to the invention usually from a predosage device, a knapsack sprayer, a spray tank, a spray plane, or an irrigation system. For this, the formulation of the invention is made up with water, optionally buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

According to one embodiment, individual components of the composition according to the invention such as parts of a kit or parts of a binary or ternary mixture may be mixed by the user himself in a spray tank and further auxiliaries may be added, if appropriate.

In a further embodiment, either individual components of the formulation according to the invention or partially premixed components, e.g. components comprising dicamba-K and/or the solvent and/or the polymer, may be mixed by the user in a spray tank and further auxiliaries and additives may be added, if appropriate. In a further embodiment, either individual components of the agrochemical composition or partially premixed components, e.g. components comprising dicamba-K and/or the solvent and/or the polymer, can be applied jointly (e.g. after tank mix) or consecutively.

The invention also relates to a method of controlling undesired vegetation, and/or for regulating the growth of plants, wherein the agrochemical composition is allowed to act on the respective pests, their environment, or the crop plants to be protected from the respective pest, on the soil and/or on the crop plants and/or on their environment.

If undesired vegetation is controlled, the formulation of the invention is usually applied on the crop plants to be protected from the undesired vegetation, on the soil and/or on the crop plants and/or on their environment. In one embodiment, the agrochemical composition is applied to the soil.

In another embodiment, the agrochemical composition is applied to the foliage.

The formulation of the invention is typically applied in a pesticidally effective amount of dicamba-salt. The term “effective amount” denotes an amount of dicamba-salt, which is sufficient for controlling pest species or the protection of materials and which does not result in a substantial damage to the crop plants. Such an amount can vary in a broad range and is dependent on various factors, such as pest species, the treated crop plant or material, and the climatic conditions.

When employed in plant protection, the amounts of dicamba-salt applied are, depending on the kind of effect desired, from 0.01 to 2 kg per ha, preferably from 0.05 to 1.5 kg per ha, more preferably from 0.1 to 1.3 kg per ha, in particular from 0.2 to 1.2 kg per ha, calculated as dicamba in the free acid form.

Depending on the application method in question, the agrochemical composition can be employed in crop plants for eliminating undesired vegetation. Examples of suitable crop plants are the following: Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera, Zea mays. Especially preferred crops are crops of cereals, corn, soybeans, rice, oilseed rape, cotton, potatoes, peanuts or permanent crops.

The compositions according to the invention can also be used in genetically modified crop plants. The term “crops” as used herein thus includes also genetically modified crop plants which have been modified by mutagenesis or genetic engineering in order to provide a new trait to a plant or to modify an already present trait. The term “genetically modified crop plants” is to be understood as plants whose genetic material has been modified by the use of recombinant DNA techniques to include an inserted sequence of DNA that is not native to that crop plant species' genome or to exhibit a deletion of DNA that was native to that species' genome, wherein the modification(s) cannot readily be obtained by cross breeding, mutagenesis or natural recombination alone. Often, a particular genetically modified crop plant will be one that has obtained its genetic modification(s) by inheritance through a natural breeding or propagation process from an ancestral crop plant whose genome was the one directly treated by use of a recombinant DNA technique. Typically, one or more genes have been integrated into the genetic material of a genetically modified crop plant in order to improve certain properties of the crop plant. Such genetic modifications also include but are not limited to targeted post-translational modification of protein(s), oligo- or polypeptides. e.g., by inclusion therein of amino acid mutation(s) that permit, decrease, or promote glycosylation or polymer additions such as prenylation, acetylation farnesylation, or PEG moiety attachment.

Mutagenesis includes techniques of random mutagenesis using X-rays or mutagenic chemicals, but also techniques of targeted mutagenesis, in order to create mutations at a specific locus of a plant genome. Targeted mutagenesis techniques frequently use oligonucleotides or proteins like CRISPR/Cas, zinc-finger nucleases, TALENs or meganucleases to achieve the targeting effect.

Genetic engineering usually uses recombinant DNA techniques to create modifications in a plant genome which under natural circumstances cannot readily be obtained by cross breeding, mutagenesis or natural recombination. Typically, one or more genes are integrated into the genome of a plant in order to add a trait or improve a trait. These integrated genes are also referred to as transgenes in the art, while plant comprising such transgenes are referred to as transgenic plants. The process of plant transformation usually produces several transformation events, witch differ in the genomic locus in which a transgene has been integrated. Plants comprising a specific transgene on a specific genomic locus are usually described as comprising a specific “event”, which is referred to by a specific event name. Traits which have been introduced in plants or hae been modified include in particular herbicide tolerance, insect resistance, increased yield and tolerance to abiotic conditions, like drought.

Herbicide tolerance has been created by using mutagenesis as well as using genetic engineering. Plants which have been rendered tolerant to acetolactate synthase (ALS) inhibitor herbicides by conventional methods of mutagenesis and breeding comprise plant varieties commercially available under the name Clearfield®. Several crop plants have been rendered tolerant to herbicides by mutagenesis and conventional methods of breeding, e.g., Clearfield® summer rape (Canola, BASF SE, Germany) being tolerant to imidazolinones, e.g., imazamox, or ExpressSun® sunflowers (DuPont, USA) being tolerant to sulfonyl ureas, e.g., tribenuron. Genetic engineering methods have been used to render crop plants such as soybean, cotton, corn, beets and rape, tolerant to herbicides such as glyphosate, imidazolinones and glufosinate, some of which are under development or commercially available under the brands or trade names RoundupReady® (glyphosate tolerant, Monsanto, USA), Cultivance® (imidazolinone tolerant, BASF SE, Germany) and LibertyLink® (glufosinate tolerant, Bayer Crop-Science, Germany). However, most of the herbicide tolerance traits have been created via the use of transgenes.

Herbicide tolerance has been created to glyphosate, glufosinate, 2,4-D, dicamba, oxynil herbicides, like bromoxynil and ioxynil, sulfonylurea herbicides, ALS inhibitor herbicides and 4-hydroxyphenylpyruvate dioxygenase (HPPD) inhibitors, like isoxaflutole and mesotrione.

Transgenes which have been used to provide herbicide tolerance traits comprise: for tolerance to glyphosate: cp4 epsps, epsps grg23ace5, mepsps, 2mepsps, gat4601, gat4621 and goxv247, for tolerance to glufosinate: pat and bar, for tolerance to 2,4-D: aad-1 and aad-12, for tolerance to dicamba: dmo, for tolerance to oxynil herbicies: bxn, for tolerance to sulfonylurea herbicides: zm-hra, csr1-2, gm-hra, S4-HrA, for tolerance to ALS inhibitor herbicides: csr1-2, for tolerance to HPPD inhibitor herbicides: hppdPF, W336 and avhppd-03.

Transgenic corn events comprising herbicide tolerance genes are for example, but not excluding others, DAS40278, MON801, MON802, MON809, MON810, MON832, MON87411, MON87419, MON87427, MON88017, MON89034, NK603, GA21, MZHGOJG, HCEM485, VCO-01981-5, 676, 678, 680, 33121, 4114, 59122, 98140, Bt10, Bt176, CBH-351, DBT418, DLL25, MS3, MS6, MZIR098, T25, TC1507 and TC6275.

Transgenic soybean events comprising herbicide tolerance genes are for example, but not excluding others, GTS 40-3-2, MON87705, MON87708, MON87712, MON87769, MON89788, A2704-12, A2704-21, A5547-127, A5547-35, DP356043, DAS44406-6, DAS68416-4, DAS-81419-2, GU262, SYHTOH2, W62, W98, FG72 and CV127.

Transgenic cotton events comprising herbicide tolerance genes are for example, but not excluding others, 19-51a, 31707, 42317, 81910, 281-24-236, 3006-210-23, BXN10211, BXN10215, BXN10222, BXN10224, MON1445, MON1698, MON88701, MON88913, GHB119, GHB614, LLCotton25, T303-3 and T304-40.

Transgenic canola events comprising herbicide tolerance genes are for example, but not excluding others, MON88302, HCR-1, HCN10, HCN28, HCN92, MS1, MS8, PHY14, PHY23, PHY35, PHY36, RF1, RF2 and RF3.

Insect resistance has mainly been created by transferring bacterial genes for insecticidal proteins to plants. Such plants are capable to synthesize one or more insecticidal proteins, especially those known from the bacterial genus Bacillus, particularly from Bacillus thuringiensis, such as delta-endotoxins, e.g., CryIA(b), CryIA(c), CryIF, CryIF(a2), CryIIA(b), CryIIIA, CryIIIB(b1) or Cry9c; vegetative insecticidal proteins (VIP), e.g., VIP1, VIP2, VIP3 or VIP3A; insecticidal proteins of bacteria colonizing nematodes, e.g., Photorhabdus spp. or Xenorhabdus spp.; toxins produced by animals, such as scorpion toxins, arachnid toxins, wasp toxins, or other insect-specific neurotoxins; toxins produced by fungi, such as Streptomycetes toxins, plant lectins, such as pea or barley lectins; agglutinins; proteinase inhibitors, such as trypsin inhibitors, serine protease inhibitors, patatin, cystatin or papain inhibitors; ribo-some-inactivating proteins (RIP), such as ricin, maize-RIP, abrin, luffin, saporin or bryodin; steroid metabolism enzymes, such as 3-hydroxy-steroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilbene synthase, bibenzyl synthase, chitinases or glucanases. In the context of the present invention these insecticidal proteins or toxins are to be understood expressly also as including pre-toxins, hybrid proteins, truncated or otherwise modified proteins. Hybrid proteins are characterized by a new combination of protein domains, (see, e.g., WO 02/015701). Further examples of such toxins or genetically modified crop plants capable of synthesizing such toxins are disclosed, e.g., in EP-A 374 753, WO 93/007278, WO 95/34656, EP-A 427 529, EP-A 451 878, WO 03/18810 und WO 03/52073. The methods for producing such genetically modified crop plants are generally known to the person skilled in the art and are described, e.g., in the publications mentioned above. These insecticidal proteins contained in the genetically modified crop plants impart to the crop plants producing these proteins tolerance to harmful pests from all taxonomic groups of arthropods, especially to beetles (Coleoptera), two-winged insects (Diptera), and moths (Lepidoptera) and to nematodes (Nematoda). Genetically modified crop plants capable to synthesize one or more insecticidal proteins are, e.g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); Bt-Xtra®, NatureGard®, KnockOut®, BiteGard®, Protecta®, Bt11 (e.g., Agrisure® CB) and Bt176 from Syngenta Seeds SAS, France, (corn cultivars producing the Cry1Ab toxin and PAT enzyme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation, Belgium (corn cultivars producing the Cry1F toxin and PAT enzyme).

However, also genes of plant origin have been transferred to other plants. In particular genes coding for protease inhibitors, like CpTI and pinII. A further approach uses transgenes in order to produce double stranded RNA in plants to target and downregulate insect genes. An example for such a transgene is dvsnf7.

Transgenic corn events comprising genes for insecticidal proteins or double stranded RNA are for example, but not excluding others, Bt10, Bt11, Bt176, MON801, MON802, MON809, MON810, MON863, MON87411, MON88017, MON89034, 33121, 4114, 5307, 59122, TC1507, TC6275, CBH-351, MIR162, DBT418 and MZIR098.

Transgenic soybean events comprising genes for insecticidal proteins are for example, but not excluding others, MON87701, MON87751 and DAS-81419.

Transgenic cotton events comprising genes for insecticidal proteins are for example, but not excluding others, SGK321, MON531, MON757, MON1076, MON15985, 31707, 31803, 31807, 31808, 42317, BNLA-601, Event1, COT67B, COT102, T303-3, T304-40, GFM Cry1A, GK12, MLS 9124, 281-24-236, 3006-210-23, GHB119 and SGK321.

Increased yield has been created by increasing ear biomass using the transgene athb17, being present in corn event MON87403, or by enhancing photosynthesis using the transgene bbx32, being present in the soybean event MON87712.

Crops comprising a modified oil content have been created by using the transgenes: gm-fad2-1, Pj.D6D, Nc.Fad3, fad2-1A and fatb1-A. Soybean events comprising at least one of these genes are: 260-05, MON87705 and MON87769.

Tolerance to abiotic conditions, in particular to tolerance to drought, has been created by using the transgene cspB, comprised by the corn event MON87460 and by using the transgene Hahb-4, comprised by soybean event IND-00410-5.

Traits are frequently combined by combining genes in a transformation event or by combining different events during the breeding process. Preferred combination of traits are herbicide tolerance to different groups of herbicides, insect tolerance to different kind of insects, in particular tolerance to lepidopteran and coleopteran insects, herbicide tolerance with one or several types of insect resistance, herbicide tolerance with increased yield as well as a combination of herbicide tolerance and tolerance to abiotic conditions.

Plants comprising singular or stacked traits as well as the genes and events providing these traits are well known in the art. For example, detailed information as to the mutagenized or integrated genes and the respective events are available from websites of the organizations “International Service for the Acquisition of Agri-biotech Applications (ISAAA)” (http://www.isaaa.org/gmapprovaldatabase) and the “Center for Environmental Risk Assessment (CERA)” (http://cera-gmc.org/GMCropDatabase), as well as in patent applications, like EP3028573 and WO2017/011288.

The use of the formulations according to the invention on crops may result in effects which are specific to a crop comprising a certain gene or event. These effects might involve changes in growth behavior or changed resistance to biotic or abiotic stress factors. Such effects may in particular comprise enhanced yield, enhanced resistance or tolerance to insects, nematodes, fungal, bacterial, mycoplasma, viral or viroid pathogens as well as early vigor, early or delayed ripening, cold or heat tolerance as well as changed amino acid or fatty acid spectrum or content.

Furthermore, crop plants are also covered that are by the use of recombinant DNA techniques capable to synthesize one or more proteins to increase the resistance or tolerance of those crop plants to bacterial, viral or fungal pathogens. Examples of such proteins are the so-called “pathogenesis-related proteins” (PR proteins, see, e.g., EP-A 392 225), crop plant dis-ease resistance genes (e.g., potato cultivars, which express resistance genes acting against Phytophthora infestans derived from the Mexican wild potato, Solanum bulbocastanum) or T4-lysozym (e.g., potato cultivars capable of synthesizing these proteins with increased resistance against bacteria such as Erwinia amylovora). The methods for producing such genetically modified crop plants are generally known to the person skilled in the art and are described, e.g., in the publications mentioned above.

Furthermore, crop plants are also covered that are by the use of recombinant DNA techniques capable to synthesize one or more proteins to increase the productivity (e.g., biomass production, grain yield, starch content, oil content or protein content), tolerance to drought, salinity or other growth-limiting environmental factors or tolerance to pests and fungal, bacterial or viral pathogens of those crop plants.

Furthermore, crop plants are also covered that contain by the use of recombinant DNA techniques a modified amount of ingredients or new ingredients, specifically to improve human or animal nutrition, e.g., oil crops that produce health-promoting long-chain omega-3 fatty acids or unsaturated omega-9 fatty acids (e.g., Nexera® rape, Dow AgroSciences, Canada).

Furthermore, crop plants are also covered that contain by the use of recombinant DNA techniques a modified amount of ingredients or new ingredients, specifically to improve raw material production, e.g., potatoes that produce increased amounts of amylopectin (e.g. Amflora® potato, BASF SE, Germany).

Furthermore, it has been found that the agrochemical compositions are also suitable for the defoliation and/or desiccation of crop plant parts, of crop plants such as cotton, potato, oilseed rape, sunflower, soybean or field beans, in particular cotton. As desiccants, the agrochemical compositions according to the invention are suitable in particular for desiccating the above-ground parts of crop plants such as potato, oilseed rape, sunflower and soybean, but also cereals. This enables a fully mechanical harvesting of these important crop plants.

Also of economic interest is the facilitation of harvesting, which is made possible by concentrating within a certain period of time the dehiscence, or reduction of adhesion to the tree, in citrus fruit, olives and other species and varieties of pomaceous fruit, stone fruit and nuts.

The same mechanism, i.e. the promotion of the development of abscission tissue between fruit part or leaf part and shoot part of the crop plants is also essential for the controlled defoliation of useful crop plants, in particular cotton.

Moreover, a shortening of the time interval in which the individual cotton crop plants mature leads to an increased fiber quality after harvesting.

Undesired vegetation to be controlled by the uses and methods of the invention are for example economically important monocotyledonous and dicotyledonous harmful plants, such as broad-leaved weeds, weed grasses or Cyperaceae. The active compounds also act efficiently on perennial weeds which produce shoots from rhizomes, root stocks and other perennial organs and which are difficult to control. Specific examples may be mentioned of some representatives of the monocotyledonous and dicotyledonous weed flora which can be controlled by the uses and methods of the invention, without the enumeration being restricted to certain species.

Examples of weed species on which the herbicidal compositions act efficiently are, from amongst the monocotyledonous weed species, Avena spp., Alopecurus spp., Apera spp., Brachiaria spp., Bromus spp., Digitaria spp., Lolium spp., Echinochloa spp., Leptochloa spp., Fimbristylis spp., Panicum spp., Phalaris spp., Poa spp., Setaria spp. and also Cyperus species from the annual group, and, among the perennial species, Agropyron, Cynodon, Imperata and Sorghum and also perennial Cyperus species. In the case of the dicotyledonous weed species, the spectrum of action extends to genera such as, for example, Abutilon spp., Amaranthus spp., Chenopodium spp., Chrysanthemum spp., Galium spp., Ipomoea spp., Kochia spp., Lamium spp., Matricaria spp., Pharbitis spp., Polygonum spp., Sida spp., Sinapis spp., Solanum spp., Stellaria spp., Veronica spp. Eclipta spp., Sesbania spp., Aeschynomene spp. and Viola spp., Xanthium spp. among the annuals, and Convolvulus, Cirsium, Rumex and Artemisia in the case of the perennial weeds. In one embodiment, the undesired vegetation is of the genus Nasturtium, preferably Nasturtium officinale.

The formulations of the present invention allow for controlling undesired vegetation on non-crop areas very efficiently, especially at high rates of application. It acts against broad-leafed weeds and grass weeds in crops such as wheat, rice, corn, soybeans and cotton without causing any significant damage to the crop plants. This effect is mainly observed at low rates of application.

The formulations of the present invention are usually applied to the plants by spraying the leaves. Here, the application can be carried out using, for example, water as carrier by customary spraying techniques using spray liquor amounts of from about 50 to 1000 I/ha (for example from 50 to 100 I/ha). Application may also involve the low-volume or the ultra-low-volume method, or the use of micro granules.

Application of the formulations of the present invention can be done before, during and/or after, preferably during and/or after, the emergence of the undesirable vegetation.

The formulations of the present invention can be applied pre- or post-emergence or together with the plant propagation material of a crop plant. It is also possible to apply the agrochemical composition by applying plant propagation material, pretreated with the agrochemical composition, of a crop plant. If dicamba-salt, or the further active compounds are less well tolerated by certain crop plants, application techniques may be used in which the herbicidal compositions are sprayed, with the aid of the spraying equipment, in such a way that as far as possible they do not come into contact with the leaves of the sensitive crop plants, while the active compounds reach the leaves of undesirable plants growing underneath, or the bare soil surface (post-directed, lay-by).

Another advantage of the invention is that the application rates of the dicamba-salt can be reduced, thereby saving costs and time. This is achieved by minimizing the primary and secondary loss profile, as defined above.

In a further aspect, the invention relates to a method for reducing fine droplet formation of an aqueous composition containing a dicamba-salt. The method comprises the step of contacting the dicamba-salt or a formulation of the dicamba salt with the solvent b) and water and optionally one further component, selected from additives d1), additives d2) and solvents e).

Alternatively, the method comprises the steps of diluting formulation of the dicamba salt, the solvent b) and water and optionally one further component, selected from additives d1), additives d2) and solvents e), with water. The invention also relates to the use of solvent b) or a combination of solvent b) with at least one component selected from the group consisting of additives d1) and d2) and solvent e) for reducing fine droplet formation during spraying of an aqueous formulation containing a dicamba-salt.

The reduction of fine droplets may be measured by determining the “Fine Droplet Ratio”. The “Fine Droplet Ratio” can be determined by quantifying within an aqueous composition the fraction of fine droplets with a mean diameter of below 105 μm, such as below 100 μm, against the fraction of larger droplets above 100 μm at 20° C. A higher fine droplet ratio con-tributes to less effective application rates of the solution to the desired crop when sprayed by conventional agricultural sprayers.

The Fine Droplet Ratio is typically measured with flat spray tip nozzle, e.g. an AIXR nozzle (“TeeJet Flat Spray Tip”) or a TTI nozzle (“Turbo TeeJet Induction Flat Spray Tip”) at a pressure of 2.76 bar. Reduction of the spray drift is typically measured in relation the same composition without the additive(s).

The term “reducing fine droplet formation” typically refers to a comparison fine droplet formation an aqueous composition containing the dicamba-salt and the solvent b) or a combination of the solvent b) with at least one component selected from the group consisting of additives d1) and d2) and solvent e), and water, with fine droplet formation of an aqueous composition 2) containing dicamba-salt, water, but none of solvent b), additives d1) and d2) and solvent e). The reduction may be at least 10%, preferably at least 20%.

In another aspect of the invention relates to a method for reducing the vapor pressure of an aqueous composition comprising dicamba-salt. The method comprises the step of contacting the dicamba-salt or a formulation of the dicamba salt with the solvent b) and water and optionally one further component, selected from additives d1), additives d2) and solvents e).

Alternatively, the method comprises the steps of diluting formulation of the dicamba salt, the solvent b) and water and optionally one further component, selected from additives d1), additives d2) and solvents e), with water. The vapor pressure is typically measured in a closed system in thermodynamic equilibrium at 20° C. It may be measured according to DIN EN 13016-1:2018-06.

The term “reducing the vapor pressure” typically refers to a comparison of the vapor pressure of an aqueous composition containing the dicamba-salt and the solvent b) or a combination of the solvent b) with at least one component selected from the group consisting of additives d1) and d2) and solvent e), and water, with the vapor pressure of an aqueous composition 2) containing dicamba-salt, water, but none of solvent b), additives d1) and d2) and solvent e). The reduction may be at least 10%, preferably at least 20%.

The invention also relates to an adjuvant composition containing the solvent b) and at least one of additives d1) or additive d2) and optionally the solvent e); and to the use of the adjuvant composition for increasing the stability of an aqueous formulation of a dicamba salt, in particular for increasing the solubility of the secondary components of the dicamba salt, in particular of dicamba-K as defined above.

The adjuvant composition(s) are usually free of water. Typically, the water content of the adjuvant composition is up to 1 wt %, preferably up to 0.5 wt %, more preferably up to 0.1 wt % based on the total weight of the adjuvant composition.

The adjuvant composition is generally free of pesticides, particularly preferably free of dicamba-salt. The adjuvant composition may be added to dicamba-salt during production of the aqueous formulation, or shortly before application in a tank mix. The adjuvant composition is usually free of water. However, it may contain water up to a concentration of 60 wt %, preferably not more than 50 wt %, in particular not more than 40 wt % or 20 wt %, and especially not more than 10 wt % based on the total weight of the adjuvant composition.

The concentration of additive d) in the adjuvant composition may be from 5 to 95 wt %, preferably from 10 to 90 wt % based on the total weight of the composition. The total concentration of solvents b) and e) in the adjuvant composition may be from 5 to 95 wt %, preferably from 10 to 90 wt % based on the total weight of the composition. In a one group of embodiments of the adjuvant composition, the additive d) comprises at least one additive d1) as a main component, i.e. the additive d1) is the sole additive d) or amounts to more than 50 wt % of all additives d). In a another group of embodiments of the adjuvant composition, the additive d) comprises at least one additive d2) as a main component, i.e. the additive d2) is the sole additive d) or amounts to more than 50 wt % of all additives d).

The adjuvant composition(s) may contain a co-solvent. Suitable co-solvents are water-miscible up to at least a ratio of the co-solvent to water of 1:1, preferably at least 2:1, more preferably at least 4:1. Suitable co-solvents are alcohols, e.g. ethanol, propanol, butanol, benzyl alcohol, cyclohexanol; glycols; DMSO; ketones, e.g. heptanone, cyclohexanone; esters, e.g., carbonates, fatty acid esters, gamma-butyrolactone; fatty acids; phosphonates; amines; amides, e.g. fatty acid dimethylamides; and mixtures thereof. In one embodiment, the co-solvent is gamma-butyrolactone. The concentration of the co-solvent in the adjuvant may be at least 1 wt %, preferably at least 2 wt %, more preferably at least 4 wt %, most preferably at least 5 wt %, based on the total weight of the agrochemical composition. The concentration of the co-solvent in the agrochemical formulation may be from 1 to 20 wt %, preferably from 1 to 10 wt %, more preferably from 2 to 8 wt %, most preferably from 4 to 7 wt %.

In one embodiment, the adjuvant composition comprises solvent b) and an additive d1). In particular embodiment, the agrochemical composition comprises N-octyl pyrrolidone, and additive d1), preferably wherein additive d1) is as defined in embodiments PA-1 or PA-2, more preferably wherein additive d1) is as defined in embodiment PA-2. In another embodiment, the adjuvant composition comprises N-butyl pyrrolidone, and additive d1), preferably wherein additive d1) is as defined in embodiments PA-1 or PA-2, more preferably wherein additive d1) is as defined in embodiment PA-2. In another embodiment, the adjuvant composition comprises N-dodecyl pyrrolidone, and additive d1), preferably wherein additive d1) is as defined in embodiments PA-1 or PA-2, more preferably wherein additive d1) is as defined in embodiment PA-2.

In one embodiment, the adjuvant composition comprises a solvent b), a C₃-C₆-lactone, and additive d1). In another embodiment, the adjuvant composition comprises gamma-butyrolactone, and additive d1), preferably wherein additive d1) is as defined in embodiments PA-1 or PA-2, more preferably wherein additive d1) is as defined in embodiment PA-2. In another embodiment, the adjuvant composition comprises epsilon-caprolactone, and additive d1), preferably wherein additive d1) is as defined in embodiments PA-1 or PA-2, more preferably wherein additive d1) is as defined in embodiment PA-2.

In one embodiment, the adjuvant composition comprises a solvent b), and additive d2). In another embodiment, the adjuvant composition comprises N-octyl pyrrolidone, and additive d2), wherein additive d2) is preferably a hyperbranched polycarbonate connected to a polyethylene glycol mono-C₁-C₁₈-alkyl ether, more preferably wherein the hyperbranched polycarbonate is connected to a polyethylene glycol monomethyl ether, most preferably wherein additive d2) a hyperbranched polycarbonate connected to polyethylene glycol monomethyl ether via a linker.

In another embodiment, the adjuvant composition comprises N-butyl pyrrolidone, and additive d2), wherein additive d2) is preferably a hyperbranched polycarbonate connected to a polyethylene glycol mono-C₁-C₁₈-alkyl ether, more preferably wherein the hyperbranched polycarbonate is connected to a polyethylene glycol monomethyl ether, most preferably wherein additive d2) a hyperbranched polycarbonate connected to polyethylene glycol monomethyl ether via a linker.

In another embodiment, the adjuvant composition comprises N-dodecyl pyrrolidone, and additive d2), wherein additive d2) is preferably a hyperbranched polycarbonate connected to a polyethylene glycol moo-C₁-C₁₈-alkyl ether, more preferably wherein the hyperbranched polycarbonate is connected to a polyethylene glycol monomethyl ether, most preferably wherein additive d2) a hyperbranched polycarbonate connected to polyethylene glycol monomethyl ether via a linker.

In another embodiment, the adjuvant composition comprises a solvent b), a C₃-C₆-lactone, and additive d2), wherein additive d2) is preferably a hyperbranched polycarbonate connected to a polyethylene glycol moo-C₁-C₁₈-alkyl ether, more preferably wherein the hyperbranched polycarbonate is connected to a polyethylene glycol monomethyl ether, most preferably wherein additive d2) a hyperbranched polycarbonate connected to polyethylene glycol monomethyl ether via a linker.

In another embodiment, the adjuvant composition comprises a solvent b), gamma-butyrolactone, and additive d2), wherein additive d2) is preferably a hyperbranched polycarbonate connected to a polyethylene glycol mono-C₁-C₁₈-alkyl ether, more preferably wherein the hyperbranched polycarbonate is connected to a polyethylene glycol monomethyl ether, most preferably wherein additive d2) a hyperbranched polycarbonate connected to polyethylene glycol monomethyl ether via a linker.

The adjuvant composition may further comprise auxiliaries. Suitable auxiliaries are as defined above for the agrochemical composition.

The invention also relates to the use of solvent b) of a combination of the solvent b) with at least one component selected from the group consisting of additives d1) and d2) and solvent e), or of the adjuvant composition for increasing the solubility of dicamba-salts in an aqueous formulation; and to a method for increasing the solubility of a dicamba-salt in an aqueous formulation comprising the step of including the solvent b) or a combination of the solvent b) with at least one component selected from the group consisting of additives d1) and d2) and solvent e), or the adjuvant composition into an aqueous formulation of a dicamba-salt.

The invention also relates to the use of solvent b) of a combination of the solvent b) with at least one component selected from the group consisting of additives d1) and d2) and solvent e), or of the adjuvant composition for increasing the solubility of side products of dicamba-salts in an aqueous formulations; and to a method for increasing the solubility of side products of dicamba-salts in an aqueous formulation comprising the step of including the solvent b) or a combination of the solvent b) with at least one component selected from the group consisting of additives d1) and d2) and solvent e), or the adjuvant composition into an aqueous formulation of a dicamba-salt.

The term “increasing the solubility” as used herein means to increase the maximum concentration of the dicamba-salt, or of the side products of said dicamba-salts that can be dissolved in a defined amount of aqueous agrochemical composition as compared to the same agrochemical formulation without the additive. The solubility of dicamba-salts or the by-products of dicamba-salts is typically measured at 20° C. in equilibrium.

The formulations of the invention and the adjuvant compositions are associated with several advantages. The formulations of the present invention, in particular the SL formulations of the dicamba-salt, and co-formulations, in particular mixtures thereof with glyphosate and/or glufosinate have a low vapor pressure, and a decreased fine droplet ratio. The formulations of the present invention can be mixed with glyphosate and/or glufosinate and/or salts thereof, or with formulations glyphosate and/or glufosinate salts, whereby co-formulated products of dicamba-salts and glyphosate and/or glufosinate are obtained which are chemically and physically stable. The formulations allow for producing aqueous formulation with high load of the respective dicamba-salt, which is in dissolved state, and which tolerate considerable amounts of secondary products of the dicamba manufacturing process. Therefore, they can cope with different product qualities of dicamba salts without the risk forming irreversible precipitates. The aqueous formulations of the present invention may contain contain considerable amounts of said by-products but still stay stable, homogenous and transparent, and the side products remain dissolved in the liquid agrochemical composition. At the same time the formulations are safe for the applicant and have a high biological efficacy.

The following examples illustrate the invention.

### EXAMPLES

The following ingredients were used for preparing the agrochemical compositions of the examples.

Dicamba-K-A: potassium salt of dicamba, 95.3% purity.

Dicamba-K-B: potassium salt of dicamba, 99.9% purity

Dicamba-K-C: potassium salt of dicamba, 93.0% purity

By products of dicamba material: 3,5-dichloro-2-methoxybenzoic acid, 3,6-dichloro-2-hydroxybenzoic acid, 3,5-dichloro-2-hydroxybenzoic acid, 3-chloro-2,6-dimethoxybenzoic acid, 3,4-dichloro-2-methoxybenzoic acid, 3,4-dichloro-2-hydroxybenzoic acid, 3,5-dichloro-4-methoxybenzoic acid and their potassium salts.

Dicamba-BAPMA: Salt of dicamba with 0.39 mol of N,N-bis-(3-aminopropyl)methylamine, containing 4-14 wt % of by-products with respect to dicamba, including 0.8-1.6 wt % of 3,5-dichloro-2-hydroxybenzoic acid and 0.5 to 3.5 of 3,6-dichloro-2-hydroxybenzoic acid, with respect to dicamba.

Dicamba-DGA: Salt of dicamba with 1.0 mol of N-(2-(2-hydroxyethyloxy)ethyl)amine, containing 4-14 wt % of by-products with respect to dicamba, including 0.8-1.6 wt % of 3,5-dichloro-2-hydroxybenzoic acid and 0.5 to 3.5 of 3,6-dichloro-2-hydroxybenzoic acid, with respect to dicamba.

Dicamba-SL: 600 g/l solution of N,N-Bis-(3-aminopropyl)methylammonium salt of dicamba in water.

Polymer A: polyalkylene oxide block-copolymer of formula (I), wherein m is from 50 to 60, and n, p are independently from 45 to 55.

Polymer B: polyalkylene oxide block-copolymer of formula (I), wherein m is from 25 to 35, and n, p are independently from 70 to 80.

Polymer C: hyperbranched polycarbonate connected to methyl polyethylene glycol, prepared as described in Synthesis Example 5 of WO2010130599

Solvent A: n-propyl lactate

Solvent B: N-(n-butyl) pyrrolidone

Solvent C: N-(n-octyl) pyrrolidone

Solvent D: N-(n-dodecyl) pyrrolidone

Solvent E: gamma-butyrolactone

Solvent F: N-(tert.-butyl) pyrrolidone

### Example-1

A soluble concentrate of dicamba-K-A was produced (SL-1). For this purpose, the following compounds were charged to a vessel in the order and amount given in Table A. The resulting mixture was then stirred until a clear and homogeneous liquid was obtained.

TABLE A
components of SL-1 in [g]

| Compound | Amount |
|---|---|
| Dicamba-K-A | 56.9 |
| Demineralized H₂O | 46.75 |
| Solvent B | 6.68 |
| Solvent E | 6.68 |
| Polymer A | 6.68 |

### Example 2

Soluble concentrates SL-2 to SL-9 were produced by analogy to the protocol of Example-1.

The amount of the ingredients is summarized in Table B. All amounts are given in [g]

TABLE B
components of SL-2 to SL-9 in [g].

| Compound | SL-2 | SL-3 | SL-4 | SL-5 | SL-6 | SL-7 | SL-8 | SL-9 |
|---|---|---|---|---|---|---|---|---|
| Dicamba-K-A | 56.66 | 56.66 | 56.66 | 56.66 | 56.66 | 56.66 | 56.66 | 56.66 |
| H2O(demin.) | 46.75 | 46.75 | 46.75 | 46.75 | 46.75 | 46.75 | 46.75 | 46.75 |
| Solvent B | — | — | 6.68 | — | — | 6.68 | — | — |
| Solvent C | 6.68 | — | — | 6.68 | — | — | 6.68 | — |
| Solvent D | — | 6.68 | — | — | 6.68 | — | — | 6.68 |
| Solvent E | 6.68 | 6.68 | 6.68 | 6.68 | 6.68 | 6.68 | 6.68 | 6.68 |
| Polymer A | 6.68 | 6.68 | — | — | — | — | — | — |
| Polymer B | — | — | 6.68 | 6.68 | 6.68 | — | — | — |
| Polymer C | — | — | — | — | — | 6.68 | 6.68 | 6.68 |

### Example-3

All soluble concentrates SL-1 to SL-9 were analyzed after preparation by visual inspection. SL-1 to SL-9 formed clear solutions comprising dicamba-K-A.

### Example-4 (Comparative Example)

Comparative soluble concentrate SL-C1 was prepared by mixing 66 wt % water and 44 wt % of Dicamba-K-A. Dicamba-K-A contained the following side products in the experimentally determined concentrations and concentration ranges provided in brackets. The values refer to the free acid of the respective side product with respect to free acid of dicamba: 3,5-dichloro-2-methoxybenzoic acid (10 to 70 g/kg), 3,6-dichloro-2-hydroxybenzoic acid (5 to 30 g/kg), 3,5-dichloro-2-hydroxybenzoic acid (0.5 to 25 g/kg).

The mixture formed a turbid liquid, full of matters in suspension that did not dissolve in the water and sedimented upon storage.

### Example-5

Fine Droplet Ratio properties of the diluted soluble concentrates SL-1 to SL-9 in admixture to glyphosate were analyzed. To this end, 1.22 L of a soluble concentrate selected from SL-1 to SL-14 was mixed with 2.07 L of a soluble concentrate comprising 540 g/l of the potassium salt of glyphosate (hereinafter “glyphosate-K”), which mixture was diluted with water to a total volume of 94 L. The resulting spray solution was then sprayed either with an AIXR nozzle (“Tee-Jet Flat Spray Tip”) or a TTI nozzle (“Turbo TeeJet Induction Flat Spray Tip”) at a pressure of 2.76 bar. The droplet size distribution was measured with a Sympatec Helos KF Laser diffraction device. Measurement was in 31 particle size classes from 18 to 3500 μm. Measurement was made at an angle of 0° at a distance of 30.5 cm from the nozzle. The analysis of data was based on 10 measurements collected in two runs. If necessary, the lenses were cleaned in-between.

For comparison, a spray solution was prepared by mixing 0.93 L of an aqueous soluble concentrate containing 754 g/L dicamba N,N-bis-(3-aminopropyl)methylammonium (SL-C2) with 2.07 L of a soluble concentrate comprising 540 g/L of the potassium salt of glyphosate and diluted with water to a total volume of 94 L. Table D shows the fractions of fine droplets for the different nozzle types and the tested soluble concentrates SL-1 to SL-10 in comparison with SL-C2.

The results are summarized in table C.

TABLE C
measurement of fine droplets <100 μm of
SL-1 to SL-9 and SL-C2 after admixture
to glyphosate potassium salt and
dilution with water

| | Fine | Fine |
|---|---|---|
| | droplets with | droplets with |
| | mean diameter | mean diameter |
| | below 100 μm | below 100 μm |
| Soluble | by spraying | by spraying |
| concentrate | with AIXR | with TTI |
| tested | nozzle in [%]. | nozzle in [%]. |
| SL-1 | 7.6 | 1.23 |
| SL-2 | 8.79 | 0.89 |
| SL-3 | 6.87 | 1.18 |
| SL-4 | 8.49 | 1.19 |
| SL-5 | 10.05 | 0.87 |
| SL-6 | 7.71 | 0.62 |
| SL-7 | 8.9 | 1.44 |
| SL-8 | 9.53 | 0.97 |
| SL-9 | 7.28 | 1.08 |
| SL-C2 | 8.58 | 1.04 |

### Example 6

Soluble concentrates SL-10 to SL-32 were produced by analogy to Example-1. The amounts of the ingredients are summarized in Tables D-1 to D-3.

TABLE D-1
components of SL-10 to SL-17 in [g].

| | SL- | SL- | SL- | SL- | SL- | SL- | SL- | SL- |
|---|---|---|---|---|---|---|---|---|
| Compound | 10 | 11 | 12 | 13 | 14 | 15 | 16 | 17 |
| Dicamba-K-A | 736.1 | 736.1 | 736.1 | 736.1 | 736.1 | 736.1 | 736.1 | 736.1 |
| H₂O_{(demin.)} | 310.1 | 281.9 | 366.5 | 338.3 | 422.9 | 394.7 | 338.3 | 394.7 |
| Solvent B | 56.4 | 84.6 | 56.4 | 84.6 | 56.4 | 84.6 | 28.2 | 28.2 |
| Polymer C | 197.4 | 197.4 | 141.0 | 141.0 | 84.6 | 84.6 | 197.4 | 141.0 |

TABLE D-2
components of SL-18 to SL-25 in [g].

| | SL- | SL- | SL- | SL- | SL- | SL- | SL- | SL- |
|---|---|---|---|---|---|---|---|---|
| Compound | 18 | 19 | 20 | 21 | 22 | 23 | 24 | 25 |
| Dicamba-K-A | 736.1 | 736.1 | 736.1 | 736.1 | 736.1 | 736.1 | 736.1 | 736.1 |
| H₂O_{(demin.)} | 451.1 | 310.1 | 281.9 | 253.7 | 253.7 | 310.1 | 366.5 | 338.3 |
| Solvent B | 28.2 | 28.2 | 56.4 | 84.6 | 112.8 | 112.8 | 112.8 | 141.0 |
| Polymer C | 84.6 | 225.6 | 225.6 | 225.6 | 197.4 | 141.0 | 84.6 | 84.6 |

TABLE D-3
components of SL-26 to SL-32 in [g].

| | SL- | SL- | SL- | SL- | SL- | SL- | SL- |
|---|---|---|---|---|---|---|---|
| Compound | 26 | 27 | 28 | 29 | 30 | 31 | 32 |
| Dicamba-K-A | 736.1 | 736.1 | 736.1 | 736.1 | 736.1 | 736.1 | 736.1 |
| H₂O_{(demin.)} | 451.1 | 422.9 | 394.7 | 366.5 | 338.3 | 366.5 | 479.3 |
| Solvent B | 84.6 | 112.8 | 141.0 | 169.2 | 197.4 | 197.4 | 84.6 |
| Polymer C | 28.2 | 28.2 | 28.2 | 28.2 | 28.2 | — | — |

### Example 7

Soluble concentrates SL-33 to SL-42 were produced in analogy to Example-1. The amounts of the ingredients are summarized in Tables E-1 and E-2.

TABLE E-1
components of SL-33 to SL-37 in [g]

| Compound | SL-33 | SL-34 | SL-35 | SL-36 | SL-37 |
|---|---|---|---|---|---|
| Dicamba-K-A [g] | — | — | | | |
| Dicamba-K-C [g] | 756.3 | 756.3 | 755.9 | 756.3 | 756.3 |
| Solvent A [g] | 16.92 | 56.4 | — | 16.92 | 56.4 |
| Solvent B [g] | 50.76 | 112.8 | 56.4 | 50.76 | 112.8 |
| Solvent E [g] | 16.92 | — | — | 16.92 | — |
| Polymer B [g] | — | — | 141.0 | 84.6 | 28.2 |
| Polymer C [g] | 84.6 | 28.2 | — | — | — |
| Water | 389.5 | 361.27 | 347.0 | 389.5 | 361.27 |
| Density [g/ml] | 1.315 | 1.315 | N.A. | 1.314 | 1.328 |
| at 20° C. | | | | | |

TABLE E-2
components of SL-38 to SL-42 in [g]

| Compound | SL-38 | SL-39 | SL-40 | SL-41 | SL-42 |
|---|---|---|---|---|---|
| Dicamba-K-B [g] | 703 | 703 | 703 | 703 | 703 |
| Solvent A [g] | 16.92 | 56.4 | — | 16.92 | 56.4 |
| Solvent B [g] | 50.76 | 112.8 | 56.4 | 50.76 | 112.8 |
| Solvent E [g] | 16.92 | — | — | 16.92 | — |
| Polymer B [g] | — | — | 141.0 | 84.6 | 28.2 |
| Polymer C [g] | 84.6 | 28.2 | — | — | — |
| Water | 389.5 | 361.27 | 347.0 | 389.5 | 361.27 |
| Density [g/ml] | 1.305 | 1.305 | N.A. | 1.305 | 1.294 |
| at 20° C. | | | | | |

### Example 8

Soluble concentrates SL-33 to SL-42 were analyzed for their volatility in the presence of glyphosate-K. To this end, 0.94 L of a soluble concentrate selected from SL-33 to SL-42 was mixed with 2.07 L of a soluble concentrate comprising 540 g/l of the potassium salt of glyphosate, which mixture was diluted with water to a total volume of 94 L. Samples were further diluted with water to ensure similar amounts of active ingredients per area in the test tubes as obtained by spraying the active ingredients at the recommended application rates in the field.

The samples were then incubated in glass tubes that were contained in water baths. The samples were incubated for 24 hours at 70° C. Volatilized sample material was constantly re-moved from the tubes by an air conduct. Residual amounts of dicamba are determined relative to the applied amount. The reported volatility is [1−(residual amount/applied amount)] in percent. The results were summarized in Table F below.

TABLE F
Volatility measured in a Büchi Multivapor P-12 for samples SL-33 to SL-42. n.m. = not measured

| Soluble concentrate | SL-33 | SL-34 | SL-36 | SL-37 | SL-38 | SL-39 | SL-40 | SL-41 | SL-42 |
|---|---|---|---|---|---|---|---|---|---|
| Volatility [%] | 16.0 | 10.6 | 13.7 | 11.3 | 7.6 | 8.2 | n.m. | 10.9 | 14.5 |

### Example 9

Soluble concentrates SL-43 to SL-51 were produced by analogy to the protocol of Example-1. The amount of the ingredients and the properties of the formulations are summarized in Table G.

The cold storage stability (stability cold) of the formulations were assessed by storing the formulation at −5° C., −10° C. and −20° C. for up to 21 days. The formulations were inspected visually with respect to crystallization. Stability was ranked by the following grades:
1 No crystallization within 21 days at −20° C. or only traces which re-dissolve upon warming to ambient temperature
2 No crystallization within 21 days at −10° C. or only traces which re-dissolve upon warming to ambient temperature but crystallization within 14 days at −20° C.
3 No crystallization within 21 days at −5° C. or only traces which re-dissolve upon warming to ambient temperature but crystallization within 14 days at −10° C.
4 Crystallization within 17 days at −5° C. Crystallization was irreversible.
5 Crystallization within 3 days at −5° C. Crystallization was irreversible.

The warm storage stability (stability (warm)) of the formulations were assessed by storing the formulation at +54° C. for 14 days followed by determining the amount of dicamba with respect to the value before storage by means of HPLC. The value is given as recovery in %.

TABLE G
Soluble concentrates SL-43 to SL-51

| | SL-43 | SL-44 | SL-45 | SL-46 | SL-47 | SL-48 | SL-49 | SL-50 | SL-51 |
|---|---|---|---|---|---|---|---|---|---|
| Dicamba-BAPMA | 536.6¹⁾ | 536.6¹⁾ | 536.6¹⁾ | 536.6¹⁾ | 536.6¹⁾ | 536.6¹⁾ | 536.6²⁾ | 536.6²⁾ | 536.6²⁾ |
| [g] | | | | | | | | | |
| Solvent B [g] | 40 | 50 | 60 | 70 | 100 | 0 | 100 | 0 | 30 |
| Solvent F [g] | 0 | 0 | 0 | 0 | 0 | 100 | 0 | 100 | 0 |
| K₂CO₃ [g] | 143 | 143 | 143 | 143 | 143 | 143 | 143 | 143 | 143 |
| water | ad 1 L | ad 1 L | ad 1 L | ad 1 L | ad 1 L | ad 1 L | ad 1 L | ad 1 L | ad 1 L |
| pH value | 9.1 | 9.1 | 9.1 | 9.1 | 9.1 | 9.1 | 9.1 | 9.1 | 9.1 |
| Stability (cold) | 1 | 2 | 3 | 3 | 2 | 2 | 2 | 2 | 2 |
| Stability (warm) | n.d. | n.d. | n.d. | n.d. | 99.2 | 98.6 | n.d. | n.d. | n.d. |
| % recovery | | | | | | | | | |
| Density [g/ml] | 1.254 | 1.254 | 1.254 | 1.254 | 1.247 | 1.249 | 1.247 | 1.249 | 1.254 |
| at 20° C. | | | | | | | | | |

¹⁾Dicamba contained 1.2 wt % of 3,5-dichloro-2-hydroxybenzoic acid
²⁾Dicamba contained 1.5 wt % of 3,5-dichloro-2-hydroxybenzoic acid

For purposes of comparison a soluble concentrate Dicamba-BAPMA SLC3 was prepared by the protocol according to Example-1 containing 536.6 g of Dicamba-BAPMA, 143 g of potassium carbonate and water ad 1 L. Cold storage stability had a ranking of 4.

### Example 10

Soluble concentrates SL-47 and SLC-3 were analyzed for their volatility by the protocol of example 8 except that they were measured as such and not mixed with a SL of glyphosate. The results are summarized in Table H below.

TABLE H
Volatility measured in a
Büchi Multivapor P-12 for
samples SL-47 and SLC-3

| Soluble | | |
|---|---|---|
| concentrate | SL-47 | SLC-3 |
| Volatility [%] | 3.9 | 4.5 |

### Example 11

Fine Droplet Ratio properties of the diluted soluble concentrates LS-C3, SL-47 and SL-48 were analyzed by the protocol of example 5 using a AIXR nozzle, except that formulations were measured as such and not mixed with a SL of glyphosate. The results are summarized in Table I below.

TABLE I
Fine droplets ratio for
samples SL-47 and SLC-3.

| Soluble concentrate | SL-47 | SL-48 | SLC-3 |
|---|---|---|---|
| Fine droplets ratio with | 8.3 | 9.2 | 7.7 |
| mean diameter below | | | |
| 100 μm by spraying | | | |
| with AIXR nozzle in [%] | | | |

### Example 12

Soluble concentrates SL-52 to SL-53 and comparative soluble concentrated SLC-4 were produced by analogy to the protocol of Example-1. The amount of the ingredients and the properties of the formulations are summarized in Table K. Stabilities were assessed as described for example 8.

TABLE K
Soluble concentrates SLC-4, SL-52 to SL-59

| Compound | SLC-4 | SL-52 | SL-53 | SL-54 | SL-55 | SL-56 | SL-57 | SL-58 | SL-59 |
|---|---|---|---|---|---|---|---|---|---|
| Dicamba-DGA [g] | 630¹⁾ | 630¹⁾ | 630¹⁾ | 630¹⁾ | 885 | 885 | 885 | 959 | 959 |
| Solvent B [g] | 0 | 50 | 75 | 100 | 50 | 75 | 100 | 50 | 75 |
| K₂CO₃ [g] | 153 | 153 | 153 | 153 | 0 | 0 | 0 | 0 | 0 |
| water | ad 1 L | ad 1 L | ad 1 L | ad 1 L | ad 1 L | ad 1 L | ad 1 L | ad 1 L | ad 1 L |
| pH value | n.d. | 10.12 | 10.16 | 10.20 | 7.0 | 7.0 | 7.1 | 7.0 | 7.1 |
| Stability (cold) ²⁾ | 5 ³⁾ | 3 | 3 | 3 | n.d. ⁵⁾ | n.d. ⁵⁾ | n.d. ⁵⁾ | n.d. ⁵⁾ | n.d. ⁵⁾ |
| Stability warm % ⁴⁾ | n.d. | 98.7 | 99.2 | 99.7 | n.d. | n.d. | n.d. | n.d. | n.d. |
| Density [g/ml] at | n.d. | 1.284 | 1.284 | 1.282 | n.d. | n.d. | n.d. | n.d. | n.d. |
| 20° C. | | | | | | | | | |

¹⁾Dicamba contained 1.2 wt % of 3,5-dichloro-2-hydroxybenzoic acid
²⁾ Storage was carried out only at −5° C. Except for SLC-4, none of the soluble concentrates showed crystallization within 28 days. Therefore, cold storage stability might even be better, because storage at −10° C. for 5 days only showed slight turbidity.
³⁾ Recipe initially formed a clear solution, wherein precipitation occurred within 24 h.
⁴⁾ % Recovery
⁵⁾ All Formulations were virtually clear and remained clear during storage at −5° C., −10° C. and −20° C. for more than 2 d

1. An aqueous SL formulation of dicamba containing
a) dicamba in the form of a dicamba salt, wherein the amount of dicamba in the formulation, calculated as free acid, is in a range of 350 to 850 g/L,
b) an organic solvent which is selected from an N—C₂-C₁₅-alkyl pyrrolidone, wherein an amount of N—C₂-C₁₅-alkyl pyrrolidone in the formulation is in a range of 10 to 200 g/L, and
water in an amount of 10 to 60 wt %.

2. The aqueous formulation according to claim 1, wherein the organic solvent is selected from the group consisting of N—C₃-C₁₂-alkyl pyrrolidones wherein the C₃-C₁₂-alkyl group is linear.

3. The aqueous formulation according to claim 2, wherein the organic solvent comprises N-butyl pyrrolidone.

4. The aqueous formulation according to claim 1, wherein an amount of the N—C₂-C₁₅-alkyl pyrrolidone in the formulation is in a range of 20 to 100 g/L.

5. The aqueous formulation according to claim 1 which further comprises at least one secondary component of dicamba selected from 3,5-dichloro-2-methoxybenzoic acid, 3,6-dichloro-2-hydroxybenzoic acid, 3,5-dichloro-2-hydroxybenzoic acid, 3-chloro-2,6-dimethoxybenzoic acid, 3,4-dichloro-2-methoxybenzoic acid, 3,4-dichloro-2-hydroxybenzoic acid, and/or 3,5-dichloro-4-methoxybenzoic acid.

6. The aqueous formulation according to claim 5, wherein a total concentration of all secondary components is in a range of 1 to 20 wt % based on the total weight of dicamba contained in the aqueous formulation.

7. The aqueous formulation according to claim 5, wherein the secondary component comprises a dichloro-2-hydroxybenzoic acid compound selected from the group consisting of 3,6-dichloro-2-hydroxybenzoic acid, 3,5-dichloro-2-hydroxybenzoic acid and 3,4-dichloro-2-hydroxybenzoic acid, and combinations thereof.

8. The aqueous formulation according to claim 1, wherein the dicamba salt is a salt of dicamba with a water-miscible organic amine having at least one amino group.

9. The aqueous formulation according to claim 8, wherein the water-miscible organic amine is selected from the group consisting of mono-C₂-C₄-alkanolamines, N,N-bis(C₂-C₄-alkanol)amines, N-(di-C₂-C₄-alkyleneglycol)amines, N-(amino-C₂-C₄-alkyl)-C₁-C₂-alkylamines, N,N-bis(amino-C₂-C₄-alkyl)-C₁-C₂-alkylamines, and N—(N′,N′-di-C₁-C₂-alkylamino-C₂-C₄-alkyl)-C₁-C₂-alkylamines.

10. The aqueous formulation according to claim 9, wherein the water-miscible organic amine is N,N-bis(3-aminopropyl)methylamine.

11. The aqueous formulation according to claim 9, wherein the water-miscible organic amine is diglycolamine.

12. The aqueous formulation according to claim 8, further comprising an inorganic buffer as a component c).

13. The aqueous formulation according to claim 12, wherein the inorganic buffer is alkali metal carbonate.

14. The aqueous formulation according to claim 8 having a pH value, measured at 20° C. and 1 bar, in a range of 6.0 to 11.0.

15. The aqueous formulation according claim 1, where the dicamba salt is the potassium salt of dicamba.

16. The aqueous formulation according to claim 15, where the formulation contains at least one polymer additive d) selected from the group consisting of
d1) a polyalkylene oxide block-copolymer of formula (I)
R¹O(EO)ₙ(PO)ₘ(EO)ₚR² (1),
wherein
EO is CH₂CH₂O;
PO is CH₂CH(CH₃)O;
R¹, R² are H or C₁-C₃-alkyl;
n, p are independently a natural number from 10 to 250; and
m is a natural number from 10 to 100; and
d2) a hyperbranched polycarbonate, which is connected to a linear polymer comprising polyethylene oxide.

17. The aqueous formulation according to claim 16 comprising the additive d1), wherein a ratio of (n+p)/m in formula I is 1:1 to 10:1.

18. The aqueous formulation according to claim 16 comprising the additive d2), wherein the hyperbranched polycarbonate is connected to a polyethyleneglycol-mono-C₁-C₁₈-alkylether.

19. The aqueous formulation according to claim 16 comprising the additive d2), wherein the hyperbranched polycarbonate contains a polyetherol based on an alcohol with at least 3 OH groups and 1 to 30 molecules alkylene oxide.

20. The aqueous formulation according to claim 16 containing a second solvent e) selected from the group consisting of C₁-C₆-alkyl lactates, C₃-C₆-lactones, and mixtures thereof.

21. The aqueous formulation according to claim 20, where the second solvent e) is a C₃-C₆-lactone.

22. The aqueous formulation according to claim 16, wherein a concentration of the sum of the solvents b) and e) and all additives d1) and d2) is in a range of 1 to 35 wt % based on the total weight of the aqueous formulation.

23. An aqueous co-formulation comprising an aqueous formulation according to claim 1, further comprising glyphosate and/or glufosinate and/or pyroxasulfone.

24. A method for producing the aqueous formulation as defined in claim 1 comprising mixing the dicamba salt with water and at least one solvent b).

25. A method for controlling undesired vegetation, and/or for regulating the growth of plants, wherein the aqueous formulation, as defined in claim 14, is allowed to act on the respective pests, their environment, or the crop plants to be protected from the respective pest, on the soil and/or on the crop plants and/or on their environment.

26. An adjuvant composition for increasing the stability of an aqueous formulation of a dicamba salt against formation of precipitates comprising a mixture of solvent b) as defined in claim 1 and at least one of additive d1) and d2).

27. (canceled)

28. (canceled)

29. A method for reducing the formation of fine droplets when spraying an aqueous spray liquor obtained by diluting a formulation of a salt of dicamba with water, comprising including a solvent b) as defined in claim 1 or a combination of solvent b) and at least one component selected from the group consisting of additives d1) and d2) and solvent e) into the formulation or into the aqueous spray liquor.

30. (canceled)

31. (canceled)

32. The aqueous formulation according to claim 2 wherein the organic solution comprises an N—C₃-C₆-alkyl pyrrolidone wherein the C₃-C₆-alkyl group is linear.
